(19) United States
(12) Patent Application Publication
(10) Pub. No.: US 2025/0301078 A1
(43) Pub. Date: Sep. 25, 2025

(54) DOCUMENT PROCESSING APPARATUS AND DOCUMENT PROCESSING SYSTEM

(71) Applicant: Jun Yamada, KANAGAWA (JP)

(72) Inventor: Jun Yamada, KANAGAWA (JP)

(73) Assignee: Ricoh Company, Ltd., Tokyo (JP)

(21) Appl. No.: 19/077,619

(22) Filed: Mar. 12, 2025

(30) Foreign Application Priority Data
Mar. 19, 2024 (JP) 2024-043924

(51) Int. Cl. H04N 1/00

(52) U.S. Cl. CPC H04N 1/0057; H04N 1/00716; H04N 1/00724; H04N 1/00745

(57) ABSTRACT

A document processing apparatus includes a document tray, a conveyor, a reading device, and circuitry. The conveyor conveys an original document from the document tray. The reading device reads an image on the original document conveyed by the conveyor as a reading operation. The circuitry is to acquire document processing information of the original document, estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus, and determine a conveyance control amount of the conveyor to convey the original document according to the conveyance-failure occurrence rate estimated.

### CROSS-REFERENCE TO RELATED APPLICATION

This patent application is based on and claims priority pursuant to 35 U.S.C. § 119(a) to Japanese Patent Application No. 2024-043924, filed on Mar. 19, 2024, in the Japan Patent Office, the entire disclosure of which is hereby incorporated by reference herein.

### BACKGROUND

### Technical Field

Embodiments of the present disclosure relate to a document processing apparatus and a document processing system.

### Background Art

Document processing apparatuses such as an automatic document feeder (ADF) mounted on a multifunction peripheral (MFP) in the art are known that include a technique of detecting a conveyance failure or a technique of changing a conveyance parameter so as not to cause a conveyance failure, by using a learning model using machine learning.

For example, a document processing apparatus in the art includes a technique known in which a feature amount of an operating sound collected by a sound collector is given to a support-vector machine that is one of supervised machine learning methods, and the feature amount is classified into any one of three classes of normal conveyance, document deformation, and sheet feed slip.

In the document processing apparatus, in order to reduce conveyance failure, a sheet feeding speed, a motor drive start timing, and a contact amount are determined according to document processing information (for example, various adjustment values such as a sheet thickness, a reading speed, registration stop control, a single-side and duplex-side reading setting, a productivity priority setting, or a silent setting). However, the number of combinations of reading conditions is enormous, and there may be a case where a combination of reading conditions that is not sufficiently examined in the design stage is generated. For this reason, in practice, there are cases where conveyance failure cannot be suppressed, or cases where a decrease in productivity occurs due to an excessive decrease in the sheet feeding speed.

As in the technique disclosed in the document processing apparatus in the art, there is a method of controlling the conveyance control amount when conveying a document by using machine learning, but in the conventional technique, it is difficult to acquire teacher data. For example, in the conventional technique, when the combination data of the document processing information and the conveyance failure occurrence probability is acquired, the document processing information from the image forming apparatus side has to be input by an operation panel or the like, and therefore, there is a problem that the work for acquiring the combination data requires time and effort.

Further, in the conventional technique, the degree of freedom in the document processing information is low, and there is a problem that the combination data of the document processing information and the conveyance failure occurrence probability cannot be acquired while freely changing the time between the leading edge of the document and the trailing edge of the next document which is continuously fed, for example.

### SUMMARY

Embodiments of the present disclosure described herein provide a novel document processing apparatus including a document tray, a conveyor, a reading device, and circuitry. The conveyor conveys an original document from the document tray. The reading device reads an image on the original document conveyed by the conveyor as a reading operation. The circuitry is to acquire document processing information of the original document, estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus, and determine a conveyance control amount of the conveyor to convey the original document according to the conveyance-failure occurrence rate estimated.

Further, embodiments of the present disclosure described herein provide a document processing system including an image forming apparatus to form an image on a sheet, and a document processing apparatus attached to the image forming apparatus and having an autonomous sheet feed and conveyance mode that autonomously feeds and conveys an original document without an instruction from the image forming apparatus. The document processing apparatus includes a document tray, a conveyor, a reading device, and circuitry. The conveyor conveys an original document from the document tray. The reading device reads an image on the original document conveyed by the conveyor as a reading operation. The circuitry is to acquire document processing information of the original document, and determine a conveyance control amount of the conveyor to convey the original document according to the conveyance-failure occurrence rate estimated based on the document processing information, as a result of the reading operation. The image forming apparatus includes circuitry to estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus.

Further, embodiments of the present disclosure described herein provide a document processing system including a document processing apparatus having an autonomous sheet feed and conveyance mode that autonomously feeds and conveys an original document without an instruction from an image forming apparatus, and an external device that communicate with the document processing apparatus. The document processing apparatus includes a document tray, a conveyor, a reading device, and circuitry. The conveyor conveys an original document from the document tray. The reading device reads to read an image on the original document conveyed by the conveyor as a reading operation. The circuitry is to acquire document processing information of the original document, and determine a conveyance control amount of the conveyor to convey the original document according to the conveyance-failure occurrence rate estimated based on the document processing information, as a result of the reading operation. The external device includes circuitry to estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating a schematic configuration of a copier according to an embodiment of the present disclosure;

FIG. 2 is a diagram illustrating a configuration of a part of an image forming device according to an embodiment of the present disclosure;

FIG. 3 is a partially enlarged view of a part of a tandem section including image forming units according to an embodiment of the present disclosure;

FIG. 4 is a perspective view of a scanner and an automatic document feeder of a copier according to an embodiment of the present disclosure;

FIG. 5 is an enlarged view of a configuration of an automatic document feeder with a scanner of an image forming apparatus according to an embodiment of the present disclosure;

FIG. 6 is a diagram illustrating a configuration of a document processing system according to an embodiment of the present disclosure;

FIG. 7 is a diagram illustrating a functional configuration of a document processing system according to an embodiment of the present disclosure;

FIG. 8 is a flowchart of a process flow of an automatic document feeder according to a first embodiment of the present disclosure;

FIG. 9 including FIGS. 9A and 9B is a diagram illustrating combination data of document processing information and a conveyance-failure occurrence rate according to an embodiment of the present disclosure;

FIG. 10 is a flowchart of an acquisition process of combination data according to an embodiment of the present disclosure;

FIG. 11 is a diagram illustrating a result of generation of a pre-trained model according to a second embodiment of the present disclosure;

FIG. 12 is a diagram illustrating a result of estimation of a conveyance-failure occurrence rate according to the second embodiment of the present disclosure;

FIG. 13 is a flowchart of a generation process of a pre-trained model according to the second embodiment of the present disclosure;

FIG. 14 is a flowchart of a process of an automatic document feeder according to the second embodiment of the present disclosure;

FIG. 15 is a diagram illustrating determination method of optimum document processing information according to the second embodiment of the present disclosure;

FIG. 16 is a diagram illustrating another example of a functional configuration of a document processing system according to an embodiment of the present disclosure; and

FIG. 17 is a diagram illustrating yet another example of a functional configuration of a document processing system according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Descriptions are given below of a basic structure of an image forming apparatus, such as a copier using an electrophotography (simply referred to as a “copier”), to which one or more of aspects of the present disclosure is applied.

A description is now given of the basic configuration of a copier as an image forming apparatus according to the present embodiment.

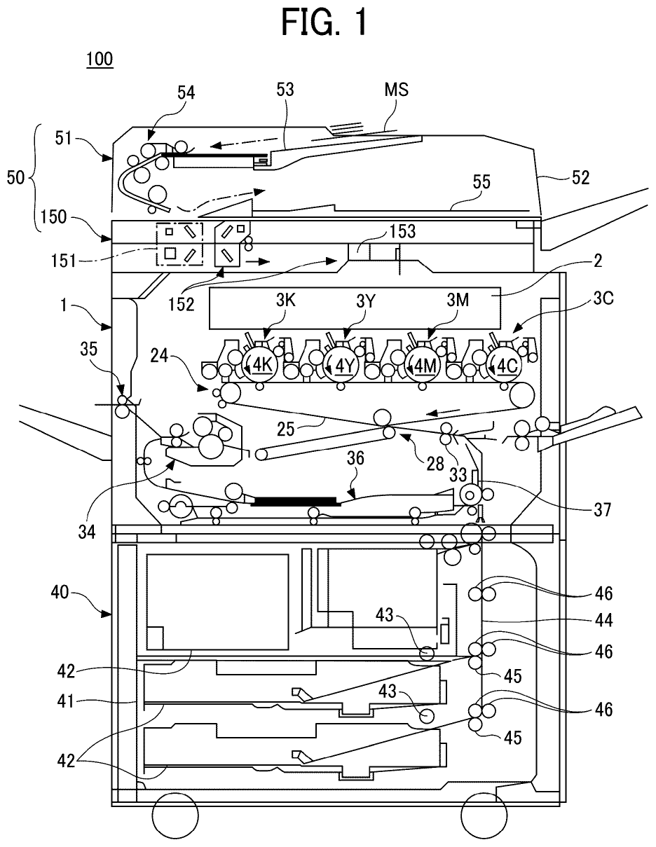

FIG. 1 is a diagram illustrating a schematic configuration of a copier according to an embodiment of the present disclosure.

In FIG. 1, a copier 100 includes an image forming device 1 as an image forming apparatus, a sheet feeding device 40, and an image reading system 50. The image reading system 50 includes a scanner 150 as an image reading device that is fixed on the image forming device 1, and an automatic document feeder 51 (referred to as an ADF 51) supported by the scanner 150.

The sheet feeding device 40 includes a sheet bank 41, two sheet trays 42 disposed in multistage one above the other in the sheet bank 41, sheet feed rollers 43 each of which picking up a recording sheet from a selected one of the two sheet trays 42, and sheet separation rollers 45 each of which separating multiple recording sheets fed by the sheet feed rollers 43. The sheet feeding device 40 further includes multiple conveyance roller pairs 46 each of which conveying the recording sheet in a sheet conveyance path 37 as a conveyance path in the image forming device 1.

Each of the two sheet trays 42 accommodates multiple recording sheets overlapping each other in a form of a sheet bundle. The sheet feed roller 43 press-contacts the uppermost sheet of the multiple recording sheets in each of the two sheet trays 42.

As the sheet feed roller 43 rotates, the uppermost recording sheet of the sheet bundle is fed from the selected one of the sheet trays 42.

The multiple conveyance roller pairs 46 are disposed near the multiple sheet trays 42. Each of the multiple conveyance roller pairs 46 includes a first conveyance roller and a second conveyance roller adjacent to (on the right side of FIG. 1 of) the first conveyance roller. The first conveyance roller and the second conveyance roller of each of the multiple conveyance roller pairs 46 are in contact with each other to form a conveyance nip region.

A sheet separation roller 45 is disposed below the first conveyance roller of each of the multiple conveyance roller pairs 46 and is in contact with the first conveyance roller from below to form a separation conveyance nip region.

A recording sheet fed from one of the sheet trays 42 driven and rotated by a corresponding one of the sheet feed rollers 43 enters the separation conveyance nip region formed by the contact of the first conveyance roller of a conveyance roller pair 46 and a sheet separation roller 45 disposed below the first conveyance roller.

In the separation conveyance nip region, the first conveyance roller that contacts the upper face of the recording sheet applies a conveyance force to the recording sheet from the sheet tray 42 toward a sheet feeding path 44 as the first conveyance roller is driven and rotated in the counterclockwise direction in FIG. 1.

In contrast, the sheet separation roller 45 that is in contact with the lower face of the recording sheet applies a conveyance force to the recording sheet from the sheet feeding path 44 toward the sheet tray 42 as the sheet separation roller 45 is driven and rotated in the counterclockwise direction in FIG. 1, thereby returning the recording sheet to the sheet tray 42.

When only one recording sheet is fed from the sheet tray 42, the first conveyance roller of the conveyance roller pair 46 and the sheet separation roller 45 apply the conveyance force to the recording sheet toward opposite directions to each other in the separation conveyance nip region. As a result, a load exceeding a given threshold value is applied to the drive transmission part of the sheet separation roller 45. Then, a torque limiter disposed in the drive transmission part of the sheet separation roller 45 is operated to cut off the transmission of the driving force from a direct current (DC) brushless motor to the sheet separation roller 45. Accordingly, the sheet separation roller 45 is rotated with the recording sheet that is conveyed by the first conveyance roller, and the recording sheet is then ejected from the separation conveyance nip region to the sheet feeding path 44.

On the other hand, when the multiple recording sheets are fed from the sheet tray 42 with the multiple recording sheets overlapped to each other, the first conveyance roller applies the conveyance force to the uppermost recording sheet of the multiple recording sheets from the sheet tray 42 toward the sheet feeding path 44 in the separation conveyance nip region. The uppermost recording sheet of the multiple recording sheets is fed from the separation conveyance nip region toward the sheet feeding path 44. On the other hand, the sheet separation roller 45 applies the conveyance force from the sheet feeding path 44 toward the sheet tray 42 to the lower recording sheet or sheets of the multiple recording sheets, so that the lower recording sheet is (or sheets are) reversed from the separation conveyance nip region toward the sheet tray 42. Accordingly, in the separation conveyance nip region, the uppermost recording sheet is separated from other recording sheet or sheets so as to be conveyed alone to the sheet feeding path 44.

The recording sheet on the sheet feeding path 44 enters the conveyance nip region of the conveyance roller pair 46 where the conveyance force is applied upward from below in the vertical direction. Accordingly, the recording sheet in the sheet feeding path 44 is conveyed toward the sheet conveyance path 37 of the image forming device 1.

The image forming device 1 includes an optical writing device 2, and four image forming units 3K, 3Y, 3M and 3C. The image forming units 3K, 3Y, 3M and 3C form black, yellow, magenta, and cyan toner images, respectively. The image forming device 1 further includes a transfer unit 24, a sheet conveyance unit 28, a registration roller pair 33, a fixing device 34, a switchback device 36, and the sheet conveyance path 37.

The optical writing device 2 includes a light source such as a laser diode and a light emitting diode (LED). The light source is disposed in the optical writing device 2. The optical writing device 2 drives the light source to emit laser lights L toward four drum-shaped photoconductors 4K, 4Y, 4M and 4C to irradiate respective surfaces of the drum-shaped photoconductors 4K, 4Y, 4M and 4C.

This emission of the laser lights L results in formation of an electrostatic latent image on each surface of the photoconductors 4K, 4Y, 4M and 4C. This electrostatic latent image is developed into a visible toner image through a given development process.

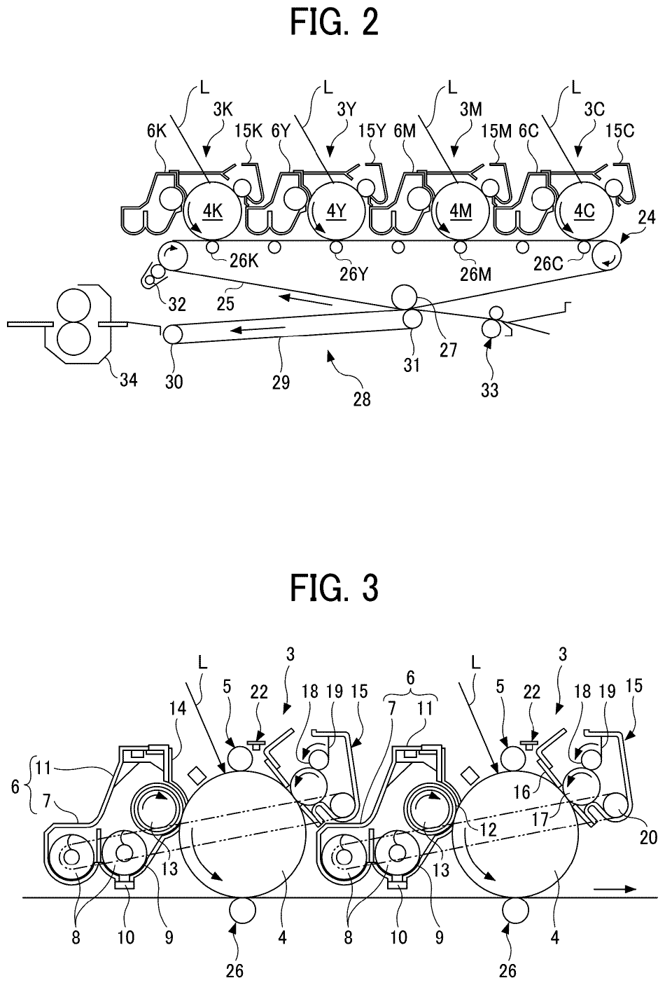

FIG. 2 is a diagram illustrating a configuration of a part of an image forming device according to an embodiment of the present disclosure.

FIG. 3 is a partially enlarged view of a part of a tandem section including an image forming units 3K, 3Y, 3M and 3C according to an embodiment of the present disclosure.

Since the four image forming units 3K, 3Y, 3M and 3C of a tandem section have respective configurations substantially the same as each other except the toner colors, the image forming units 3K, 3Y, 3M, and 3C are also described without suffixes indicating the toner colors, which are K, Y, M and C in FIG. 3. For example, the image forming units 3K, 3Y, 3M and 3C may be also referred to as an “image forming unit 3” in a single form.

Each of the image forming units 3K, 3Y, 3M and 3C also includes respective image forming components disposed around the corresponding one of the photoconductors 4K, 4Y, 4M and 4C, as a single unit, supported by a common support member. The image forming units 3K, 3Y, 3M and 3C are detachably attached to the image forming device 1.

The image forming unit 3 (i.e., the image forming units 3K, 3Y, 3M and 3C) includes the photoconductor 4 (i.e., the photoconductors 4K, 4Y, 4M and 4C), and a charging device 5, a developing device 6 (i.e., developing devices 6K, 6Y, 6M and 6C), a drum cleaning device 15 (i.e., drum cleaning devices 15K, 15Y, 15M and 15C), and an electric discharging lamp 22 around the photoconductor 4.

The copier 100 is a tandem image forming system in which the four image forming units 3K, 3Y, 3M and 3C are aligned in a direction of movement of an intermediate transfer belt 25 as an endless loop, which is described below.

The photoconductors 4K, 4Y, 4M and 4C is manufactured by a hollow tube made of aluminum, for example, with a drum shape covered by an organic photoconductive layer having photosensitivity. Alternatively, the photoconductor 3 may have an endless belt shape.

The developing device 6 (i.e., developing devices 6K, 6Y, 6M and 6C) develops an electrostatic latent image into a visible toner image by a two-component developer including magnetic carrier particles and non-magnetic toner. The two-component developer is now referred to as a “developer”. The developing device 6 includes an agitating portion 7 and a development portion 11. The agitating portion 7 stirs the two-component developer accommodated therein and conveys the two-component developer to a development sleeve 12. The development portion 11 supplies the non-magnetic toner, which is included in the two-component developer and held by the development sleeve 12, to the developing device 4 (i.e., photoconductors 4K, 4Y, 4M, and 4C).

The agitating portion 7 is located at a position lower than the development portion 11 and includes two screw, a partition, a development case 9, and a toner concentration sensor 10. The two transfer screws 8 are disposed in parallel to each other. The partition is disposed between the two transfer screws 8. The development case 9 has an opening or a slot to face the photoconductor 4. The toner concentration sensor 10 is disposed on the bottom of the development case 9.

The development portion 11 includes the development sleeve 12, a magnetic roller 13, and a doctor blade 14. The development sleeve 12 faces the photoconductor 4 (i.e., the photoconductors 4K, 4Y, 4M and 4C) through the opening (or the slot) of the development case 9. The magnetic roller 13 is fixedly or unrotatably disposed inside the development sleeve 12. The doctor blade 14 is disposed adjacent to the development sleeve 12 and the leading end of the doctor blade 14 is disposed close to the development sleeve 12. The development sleeve 12 has a non-magnetic, rotatable tubular body.

The magnetic roller 13 has multiple magnetic poles arranged in the order in a rotation direction of the development sleeve 12, starting from an opposed position to the doctor blade 14. Each of these magnetic poles applies a magnetic force at a predetermined position in the rotation direction of the development sleeve 12, with respect to the two-component developer supplied on the development sleeve 12. With this action of the magnetic roller 13, the two-component developer that is conveyed from the agitating portion 7 is attracted and attached to the surface of the development sleeve 12 and a magnetic brush of toner is formed along the lines of the magnetic force on the surface of the development sleeve 12.

In accordance with rotation of the development sleeve 12, the magnetic brush is restricted to have an appropriate layer thickness when passing by the opposed position to the doctor blade 14. Then, the magnetic brush is moved to a development region facing the photoconductors 4K, 4Y, 4M and 4C. Due to a difference of potentials between a development bias that is applied to the development sleeve 12 and an electrostatic latent image formed on the surface of the photoconductor 4 (i.e., the photoconductors 4K, 4Y, 4M and 4C), the toner is transferred onto the electrostatic latent image, so that the electrostatic latent image is developed into a visible toner image.

Further, after returning into the development portion 11 again along with the rotation of the development sleeve 12 then leaving from the surface of the development sleeve 12 due to repulsion of the magnetic field formed between the magnetic poles of the magnetic roller 13, the two-component developer in a form of the magnetic brush is returned to the agitating portion 7. An appropriate amount of toner is supplied to the two-component developer in the agitating portion 7 based on a result or results detected by the toner concentration sensor 10. Alternative to the two-component developer, the developing device 6 according to the present embodiment may employ one-component developer that does not include magnetic carriers.

The drum cleaning device 15 (i.e., drum cleaning devices 15K, 15Y, 15M and 15C) includes a cleaning blade 16, a fur brush 17, an electric field roller 18, a scraper 19, a collection screw 20, and an outside recycle toner device 21.

The cleaning blade 16 is an elastic member to be pressed against the photoconductor 4, so as to scrape residual toner remaining on the surface of the photoconductor 4. In the present embodiment, the drum cleaning device 15 employs a blade member such as the cleaning blade 16, however, the configuration is not limited thereto. Alternative to the blade member, a brush roller, for example, can be applied to the drum cleaning device 15.

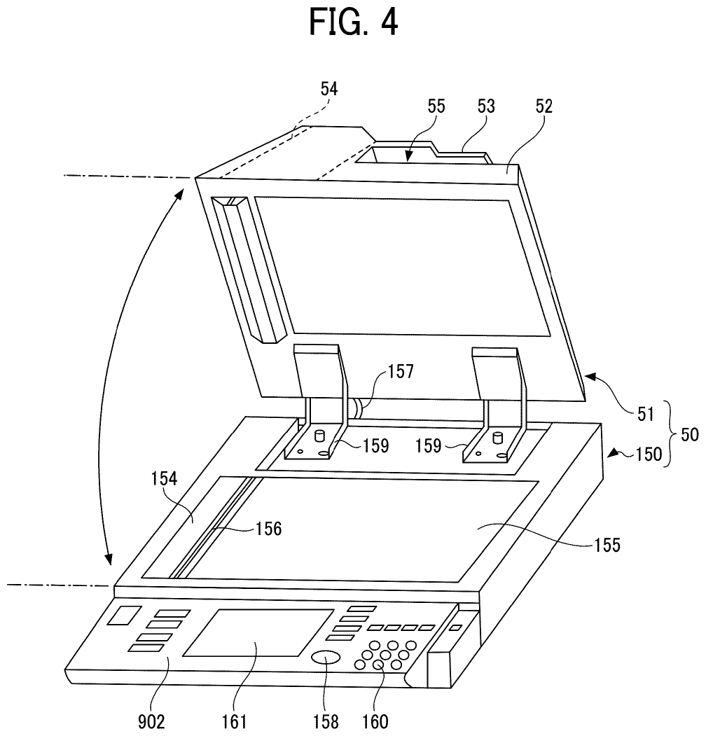

The fur brush 17 according to the present embodiment is provided in order to increase the cleanability. The fur brush 17 is a conductive member and the outer circumferential surface of the fur brush 17 slidably contacts the photoconductor 4 (i.e., the photoconductors 4K, 4Y, 4M and 4C). The fur brush 17 according to the present embodiment is rotatable in a direction indicated by arrow in FIG. 4.

The fur brush 17 also functions as an applier that scrapes a solid lubricant to obtain fine powder of lubricant and applies the scraped fine powder to the surface of the photoconductor 4 (i.e., the photoconductors 4K, 4Y, 4M and 4C).

The electric field roller 18 is a metallic member that applies a bias to the fur brush 17. The electric field roller 18 is disposed rotatably in a direction indicated by arrow in FIG. 3.

The scraper 19 has a leading end that is pressed against the electric field roller 18. The toner removed from the photoconductor 4 and attached to the fur brush 17 is transferred onto the electric field roller 18 that contacts the fur brush 17 in a counter direction to be applied with a bias while the electric field roller 18 is rotating. After being scraped and removed from the electric field roller 18 by the scraper 19, the toner collected by the scraper 19 falls onto the collection screw 20.

The collection screw 20 conveys the toner collected from the surface of the photoconductor 4 toward an end portion of the drum cleaning device 15 in a direction orthogonal to the drawing sheet, and transfers the collected toner to an external toner recycling transfer device.

The external toner recycling transfer device sends the collected toner to the developing device 6 (i.e., developing devices 6K, 6Y, 6M and 6C) for recycling.

The electric discharging lamp 22 removes residual electric charge remaining on the surface of the photoconductors 4K, 4Y, 4M and 4C by photo irradiation. After such residual electric charge is removed, the electrically discharged surface of the photoconductor 4 (i.e., photoconductors 4K, 4Y, 4M and 4C) is uniformly charged by the charging device 5 again and then optically irradiated by the optical writing unit 2. In the image forming device 1 according to the present embodiment, the charging device 5 illustrated in FIG. 3 is a charging roller that is applied with charging bias and rotates while contacting the photoconductor 4 (i.e., the photoconductors 4K, 4Y, 4M and 4C). However, in some embodiments, the charging device 5 may be a scorotron charger that performs a charging process on the photoconductor 4 (i.e., the photoconductors 4K, 4Y, 4M and 4C) in non-contact with the photoconductor 4.

According to the above-described operations with the configuration illustrated in FIG. 2, black (K), yellow (Y), magenta (M), and cyan (C) toner images are formed on the photoconductors 4K, 4Y, 4M and 4C of the image forming units 3K, 3Y, 3M and 3C, respectively.

The transfer unit 24 is disposed below the image forming units 3K, 3Y, 3M and 3C. The transfer unit 24 endlessly moves the intermediate transfer belt 25 in the clockwise direction in FIG. 2 while the intermediate transfer belt 25 is stretched by and would around multiple rollers and is in contact with the photoconductors 4K, 4Y, 4M and 4C. By so doing, respective primary transfer nip regions for forming black, yellow, magenta, and cyan images are formed between the photoconductors 4K, 4Y, 4M and 4C and the intermediate transfer belt 25 of an endless loop in contact with each other.

In proximity to each of the primary transfer nip regions for black, yellow, magenta, and cyan images, the primary transfer rollers 26 (i.e., the primary transfer rollers 26K, 26Y, 26M and 26C) are disposed in contact with the inner loop of the intermediate transfer belt 25 to press the intermediate transfer belt 25 against the photoconductors 4 (i.e., the photoconductors 4K, 4Y, 4M and 4C), respectively.

A primary transfer bias is applied by respective transfer bias power supplies to the primary transfer rollers 26K, 26Y, 26M and 26C. Consequently, respective primary transfer electric fields are generated in the primary transfer nip regions to electrostatically transfer respective toner images formed on the photoconductors 4K, 4Y, 4M and 4C onto the intermediate transfer belt 25.

As the intermediate transfer belt 25 passes through the primary transfer nip regions along the endless rotation in the clockwise direction in FIG. 2, the black (K), yellow (Y), magenta (M) and cyan (C) toner images are sequentially transferred at the primary transfer nip regions and overlaid onto an outer circumferential surface of the intermediate transfer belt 25. Due to the primary transfer of the toner images, a four-color composite toner image (referred to as a four-color toner image) is formed on the surface of the intermediate transfer belt 25.

The sheet conveyance unit 28 is disposed below the transfer unit 24 in FIG. 2. The sheet conveyance unit 28 includes a sheet transfer belt 29, a sheet transfer belt drive roller 30, and a secondary transfer roller 31. The sheet transfer belt 29 is an endless belt that is wound around the sheet transfer belt drive roller 30 and the secondary transfer roller 31 and rotates in a direction indicated by arrow in FIG. 2. As illustrated in FIG. 2, the intermediate transfer belt 25 and the sheet transfer belt 29 are sandwiched between the secondary transfer roller 31 and a lower tension roller 27 of the transfer unit 24. According to this configuration, a secondary transfer nip region is formed between the surface of the intermediate transfer belt 25 and the surface of the sheet transfer belt 29 contacting with each other. A secondary transfer bias is applied by a transfer bias power source to the secondary transfer roller 31. On the other hand, the lower tension roller 27 of the transfer unit 24 is electrically grounded. By so doing, a secondary transfer electric field is formed in the secondary transfer nip region.

The registration roller pair 33 is disposed on a right side of the secondary transfer nip region in FIGS. 2 and 3. A registration roller sensor is disposed adjacent to an entrance of the registration nip region of the registration roller pair 33. The recording sheet is conveyed from the sheet feeding device 40 to the registration roller pair 33. After a given time has elapsed from the detection of the leading end of the recording sheet by the registration roller sensor, the conveyance of the recording sheet temporarily stops, and the leading end of the recording sheet contacts the registration nip region of the registration roller pair 33.

After the leading end of the recording sheet contacts the registration nip region of the registration roller pair 33, the registration roller pair 33 restarts the rotation to synchronize the movement of the recording sheet with the movement of the four-color toner image formed on the intermediate transfer belt 25. Consequently, the recording sheet nipped between the registration roller pair 33 is conveyed to the secondary transfer nip region.

When the four-color toner image formed on the intermediate transfer belt 25 closely contacts the recording sheet at the secondary transfer nip region, the four-color toner image on the intermediate transfer belt 25 is transferred onto the recording sheet in the secondary transfer due to the secondary transfer electric field or the nip pressure. At this time, the four-color toner image is combined with white color of the recording medium to make a full-color image. After passing through the secondary transfer nip region, the recording sheet having the full-color toner image on the surface is separated from the intermediate transfer belt 25. Then, while being held on the front face of the sheet transfer belt 29, the recording sheet is conveyed to the fixing device 34 along with endless rotation of the sheet transfer belt 29 in the direction as illustrated in FIG. 3.

Residual toner that has not been transferred onto the recording sheet in the secondary transfer nip region remains on the surface of the intermediate transfer belt 25 after the intermediate transfer belt 25 has passed through the secondary transfer nip region. The residual toner is scraped and removed from the surface of the intermediate transfer belt 25 by a belt cleaning device 32 that is disposed in contact with the surface of the intermediate transfer belt 25.

The recording sheet is conveyed to the fixing device 34. The fixing device 34 fixes the full-color toner image to the recording sheet by application of heat and pressure. Then, the recording sheet is conveyed from the fixing device 34 to the sheet ejection roller pair 35 to be ejected to the outside of the image forming device 1.

As illustrated in FIG. 1, the switchback device 36 is disposed below the sheet conveyance unit 28 and the fixing device 34. As a result of the above-described operation, after the image fixing operation is performed on one side or the surface of the recording sheet, a switching member switches the direction of conveyance of the recording sheet. Specifically, the direction of conveyance of the recording sheet is switched to a passage to the switchback device 36 by the switching member. When the recording sheet is conveyed to the transfer reversal device, the recording sheet is reversed to enter the secondary transfer nip region of the copier 100 again. In the image forming device 1, a toner image is secondarily transferred onto the other side or a back face of the recording sheet so that the secondary transfer process and the fixing process are executed. Then, the recording sheet is ejected onto the ejection tray.

The scanner 150 fixed to the image forming device 1 includes a movable reading unit 152. The scanner 150 and the ADF 51 include fixed reading units. The movable reading unit 152 is disposed immediately below a second exposure glass 155 (see FIG. 4) that is fixedly mounted on the upper wall of a casing of the scanner 150 so as to contact an original document MS. The movable reading unit 152 includes a light source and optical process units such as multiple reflection mirrors, so that these optical units can move in a horizontal direction (in other words, left and right directions) in FIG. 1. In the course of moving the optical components from left to right in FIG. 1, the light source emits the light. After a surface of the original document MS placed on the second exposure glass 155 reflects light, the reflected light is further reflected on multiple reflection mirrors until an image reading sensor 153 that is fixed to the scanner 150 receives the reflected light.

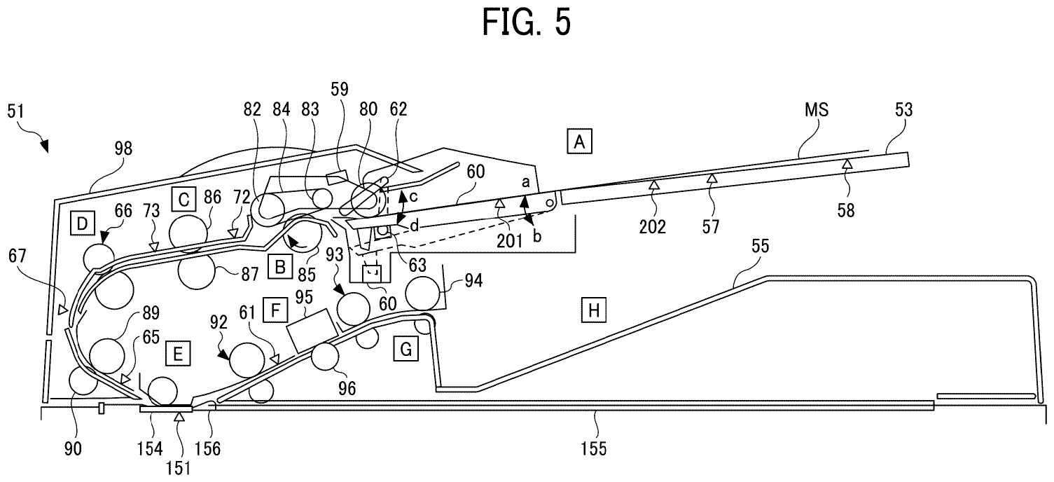

In contrast, the fixed reading units include the first fixed reading unit 151 disposed inside the scanner 150, and a second fixed reading unit 95 (FIG. 5) disposed inside the ADF 51. The first fixed reading unit 151 includes a light source, multiple reflection mirrors, and the image reading sensor 153 such as CCD. The first fixed reading unit 151 is disposed immediately below a first exposure glass 154 (FIG. 4) that is fixed to the upper wall of the casing of the scanner 150, so that the first exposure glass 154 contacts the original document MS.

When the sheet-like original document MS that is conveyed by the ADF 51 (described below) passes over the first exposure glass 154, the light source emits light. After a document face of the original document MS sequentially reflects the light emitted from the light source, the reflected light is further reflected on multiple reflection mirrors until the image reading sensor 153 receives the reflected light. By so doing, the first face of the original document MS is scanned without moving the optical components such as the light source and the multiple reflection mirrors.

Further, the second fixed reading unit 95 scans or reads the second side or the back surface of the original document MS after the original document MS has passed the first fixed reading unit 151.

The first fixed reading unit 151 and the movable reading unit 152 may be a single unit.

In this case, the movable reading unit 152 scans the original document when the movable reading unit 152 is under the first exposure glass 154, so that the movable reading unit 152 may function as the first fixed reading unit 151.

The ADF 51 that is disposed on the scanner 150 includes a body cover 52, a document loading tray 53, a document conveyance unit 54, and a document stacking table 55. The body cover 52 holds and supports the document loading tray 53. The document loading tray 53 loads the original document MS to be read. The ADF 51 also holds and supports the document conveyance unit 54 and the document stacking table 55. The document conveyance unit 54 conveys the original document MS as a sheet member. The document stacking table 55 receives and stacks the original document MS after the original document MS is read.

FIG. 4 is a perspective view of a scanner and an automatic document feeder (ADF) of a copier according to an embodiment of the present disclosure.

As illustrated in FIG. 4, the ADF 51 is supported to be rotatable in the upward and downward directions by hinges 159 each being fixed to the scanner 150. With the rotation of the ADF 51 in the upward and downward directions, the ADF 51 works as an opening door, so that the first exposure glass 154 and the second exposure glass 155 on the upper face of the scanner 150 are exposed while the ADF 51 is open. In a case of the one-sided bound documents such as a book of a document bundle bounded on one-side, the original documents MS are not separated one by one. For this reason, the original documents MS in the above-described form are not conveyed by the ADF 51. When reading the one-sided bound documents, the ADF 51 is opened as illustrated in FIG. 4. After the ADF 51 is opened as illustrated in FIG. 4, the one-sided bound documents are placed on the second exposure glass 155 with a page to be read facing down. Then, the ADF 51 is closed. Then, the scanner 150 causes the movable reading unit 152 illustrated in FIG. 1 to read the image on the page of the one-sided bound documents placed facedown.

On the other hand, when the original documents MS are in a form of a document bundle of simply accumulated individual original documents MS, the original documents MS are sequentially read by the first fixed reading unit 151 in the scanner 150 and the second fixed reading unit 95 in the ADF 51 while the ADF 51 automatically conveys the original documents MS one by one.

In this case, a copy start key 158 is pressed after the bundle of original documents is placed on the document loading tray 53 of the ADF 51. Then, the ADF 51 starts conveyance of the original documents MS that are a bundle of original documents stacked on the document loading tray 53 to convey the original documents MS sequentially from top of the bundle of original documents MS to the document conveyance unit 54 one by one, and further convey the original documents MS to the document stacking table 55 while reversing the original document MS. In the course of this conveyance of the original documents MS, immediately after the original document MS is reversed, the original document MS is caused to pass immediately above the first fixed reading unit 151 of the scanner 150. At this time, the image on the first face of the original document MS is read by the first fixed reading unit 151 of the scanner 150.

FIG. 5 is an enlarged view of a configuration of the ADF 51 with the scanner 150 of the copier 100 according to an embodiment of the present disclosure.

The ADF 51 according to the present embodiment includes, for example, a document setting part A, a document separating and feeding part B, a registration part C, a document turning part D, a first reading and conveying part E, a second reading and conveying part F, a document ejecting part G, and a document stacking part H. Further, the ADF 51 includes a document conveyance path for conveying the original document MS from the document loading tray 53 toward the first fixed reading unit 151 that is an image reading position.

The document setting part A has the document loading tray 53 on which a bundle of original documents MS is placed.

The document separating and feeding part B separates and feeds the original document MS one by one from the bundle of the original documents MS set on the document loading tray 53.

In the registration part C, the original document MS fed from the document separating and conveying part B temporarily contacts the original document MS to be aligned and fed again.

The document turning part D has a conveyance passage curved in a C-shape, and turns the original document MS to be conveyed in the curved conveyance passage so as to reverse the original document MS upside down while turning the original document MS.

Then, in the first reading and conveying part E, the first fixed reading unit 151 disposed in the scanner below the first exposure glass 154 as illustrated in FIG. 5 reads the first face of the original document MS while the original document MS is being conveyed on the first exposure glass 154.

Further, in the second reading and conveying part F, the second fixed reading unit 95 reads the second face of the original document MS while the original document MS is conveyed under the second fixed reading unit 95.

After the images on both sides of the original document MS are read, the original document MS is conveyed in the document ejecting part G to be ejected toward the document stacking part H.

In the document stacking part H, the original documents MS are placed and stacked on the document stacking table 55.

The original document MS is set in the document setting part A with the leading end of the original document MS placed on the movable document table 60 serving as a sheet tray rotatable in the directions indicated by arrows “a” and “b” in FIG. 5 depending on the thicknesses of a bundle of the original documents MS and the trailing end of the original document MS placed on the document loading tray 53.

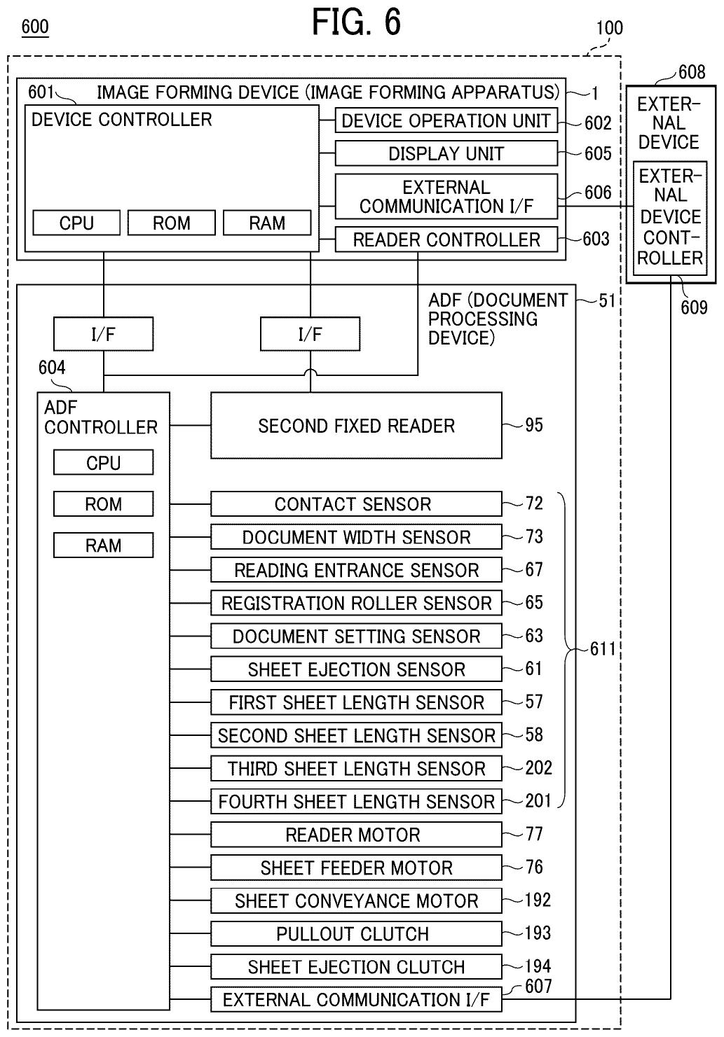

The side guides of the document loading tray 53 contact both lateral side ends of the original document MS in the width direction (i.e., the direction orthogonal to the drawing sheet) to adjust the position of the original document MS in the width direction. The original documents MS thus set push up a lever 62 that is rotatably disposed above the movable document table 60. Along with this movement of the original documents MS, the document set sensor 63 detects the setting of the original documents MS, and transmits the detection signal to the ADF controller 604 (see FIG. 6). The detection signal is then transmitted from the ADF controller 604 to a reader controller 603 (see FIG. 6) of the scanner 150 via an interface (I/F).

A first length sensor 57, a second length sensor 58, a third length sensor 202, and a fourth length sensor 201 are held on the document loading tray 53. Each of the first length sensor 57, the second length sensor 58, the third length sensor 202, and the fourth length sensor 201 includes a reflective photosensor or an actuator-type sensor for detecting the length of the original document MS in the conveyance direction of the original document MS.

The third length sensor 202 is, for example, a length sensor for a check.

The fourth length sensor 201 is, for example, a length sensor for a business card.

A description is given below of an example of the third length sensor 202 as a length sensor for a check and the fourth length sensor 201 as a length sensor for a business card.

The first length sensor 57, the second length sensor 58, the third length sensor 202, and the fourth length sensor 201 detect the length of the original document MS in the conveyance direction of the original document MS.

The third length sensor 202 is disposed at a position where the third length sensor 202 is slightly not turned on when the check is placed on the document tray.

The fourth length sensor 201 is arranged at a position where the fourth length sensor 201 is slightly not turned on when the business card is placed on the document tray.

Whether an original document of specified size such as a business card or a check is placed is detected from the detection information of the first length sensor 57, the second length sensor 58, the third length sensor 202, and the fourth length sensor 201. Since the length of a check is 185 mm and the length of a business card is 91 mm, the rough indication of the position of the third length sensor 202 is approximately 190 mm and the rough indication of the position of the fourth length sensor 201 is approximately 96 mm, with reference to the fence against which the leading end of the document set on the document tray contacts.

The pickup roller 80 is supported by the cam mechanism to be movable in the vertical direction (i.e., the directions indicated by arrows c and d in FIG. 5) and is disposed above the bundle of original documents MS stacked on the movable document table 60. The cam mechanism is driven by the pickup motor 56 to move the pickup roller 80 in the vertical direction. As the pickup roller 80 moves upward, the movable document table 60 rotates in the direction indicated by arrow “a” in FIG. 5, so that the pickup roller 80 is brought to contact the uppermost original document MS placed on top of the bundle of original documents MS.

As the movable document table 60 further moves upward, a table elevation detection sensor 59 detects that the movable document table 60 moves up to the maximum height. In response to this detection, the pickup motor 56 stops driving to stop the movable document table 60 from moving up.

The device operation unit 602 including a numeric keypad 160 and a display 161 mounted on the housing of the copier 100 is operated by the user (operator) to perform, for example, a key operation for setting a reading mode indicating a double-sided reading mode or a single-sided reading mode and a pressing operation of the copy start key 158. As the copy start key 158 is pressed by the user, the document feeding signal is sent to the ADF controller 604 of the ADF 51 from a device controller 601 (see FIG. 6). In response to the sending of the document feeding signal, the pickup roller 80 is rotated along with the forward rotation of the sheet feed motor 76, so that the original documents MS on the movable document table 60 are fed from the movable document table 60.

The setting of the double-sided reading mode or the single-sided reading mode collectively covers the whole original documents MS stacked on the movable document table 60. To be more specific, when the double-sided reading mode or the single-sided reading mode is set, both sides or a single-side of the whole original documents MS stacked on the movable document table 60 can be read. In addition, individual reading mode setting can be performed on separate ones of the original documents MS. For example, the double-sided reading mode can be applied to the first and 10th original documents MS and the single-sided reading mode can be applied to the other original documents MS.

The original document MS fed by the pickup roller 80 enters the document separating and feeding part B to be fed to the contact position with the sheet feed belt 84. The sheet feed belt 84 is wound and stretched by, for example, a drive roller 82 to be endlessly moved in the clockwise direction in FIG. 5 by rotation of the drive roller 82 along with the forward rotation of the sheet feed motor 76.

A separation roller 85 is in contact with the lower stretched face of the sheet feed belt 84 to be rotated in the clockwise direction in FIG. 5 along with the forward rotation of the sheet feed motor 76. At the contact portion, the sheet feed belt 84 is rotated so that the surface of the sheet feed belt 84 moves in the conveyance direction of the original document MS. The separation roller 85 is pressed against the sheet feed belt 84 with a predetermined pressure. When the separation roller 85 directly contacts the sheet feed belt 84 or a single original document MS is nipped in the contact portion, the separation roller 85 is rotated with rotation of the sheet feed belt 84 or movement of the original document MS. However, when multiple original documents MS are nipped in the contact portion, the force of the separation roller 85 to be rotated with rotation of the sheet feed belt 84 or movement of the original document MS is lower than the torque of a torque limiter. For this reason, the separation roller 85 is rotated in the clockwise direction that is opposite to a direction in which the separation roller 85 is rotated. As a result, the separation roller 85 applies the force of movement in the direction opposite to the sheet conveyance direction, to the original documents MS under the uppermost original document MS, so that the uppermost original document MS along is separated from the multiple original documents MS under the uppermost original document MS. The above-described operation is referred to as a sheet feeding and separating operation.

The original document MS is separated from the other original documents MS through the operations of the sheet feed belt 84 and the separation roller 85, and enters the registration part C. Then, the leading end of the original document MS is detected by the document contact sensor 72 when the original document MS passes directly under the document contact sensor 72. At this time, the pickup roller 80 receiving the driving force of the pickup motor 56 is still rotating. However, as the pickup roller 80 is separated from the original document MS due to descendance of the movable document table 60, the original document MS is conveyed only by an endless moving force of the sheet feed belt 84.

Then, the endless movement of the sheet feed belt 84 is continued for a given time from the timing at which the leading end of the original document MS is detected by the document contact sensor 72. Then, the leading end of the original document MS contacts the contact portion of the pullout driven roller 87 and the pullout drive roller 86 that rotates while contacting the pullout drive roller 86. At this time, the contact portion of the pullout driven roller 87 and the pullout drive roller 86 is separated from the original document MS, from the timing at which the leading end of the original document MS is detected by the document contact sensor 72. By so doing, the timing to start conveying the original document MS by the endless movement force of the sheet feed belt 84 alone can be increased or decreased. By increasing or decreasing the timing to start conveying the original document MS by the endless movement force of the sheet feed belt 84 alone, the contact amount of the original document MS to contact the contact portion with the pullout driven roller 87 can be adjusted.

If the speed of the original document MS at this time is 500 mm/s, the contact amount can be increased by 1 mm by delaying the timing to separate the contact portion from the original document MS by 2 msec. The equation is expressed by (500 mm/sec×0.002 sec=1 mm). The pullout driven roller 87 has a function of conveying the original document MS to the intermediate roller pair 66 downstream from the pullout driven roller 87 in the document conveyance direction, and is driven and rotated by the rotation of the sheet feed motor 76 in the reverse direction. As the sheet feed motor 76 rotates in the reverse direction, the pullout driven roller 87 and one roller of the intermediate roller pair 66 contacting the pullout driven roller 87 start rotating and the endless movement of the sheet feed belt 84 stops. At this time, the pickup roller 80 stops rotating.

The original document MS that is fed by the pullout driven roller 87 passes directly under the document width sensor 73. The document width sensor 73 includes multiple sheet detectors each including a reflective photosensor. The multiple sheet detectors are aligned in a row in the width direction of the original document MS (i.e., the direction perpendicular to the drawing sheet of FIG. 5). The size of the original document MS in the width direction is detected based on which one of the multiple document detectors detects the original document MS. The length of the original document MS in the document conveyance direction is detected based on the time from when the leading end of the original document MS is detected by the document contact sensor 72 to when the trailing end of the original document MS is not detected by the document contact sensor 72.

The leading end of the original document MS whose size in the width direction is detected by the document width sensor 73 enters the document turning part D and is nipped by the contact portion between the rollers of the intermediate roller pair 66. The conveyance speed of the original document MS conveyed by the intermediate roller pair 66 is set faster than the conveyance speed of the original document MS in the first reading and conveying part E that will be described below. This configuration achieves a reduction in time for conveying the original document MS to the first reading and conveying part E.

As described above, the size of an original document MS can be detected by the document width sensor 73, the first length sensor 57, the second length sensor 58, the third length sensor 202, and the fourth length sensor 201. On the other hand, the user can also designate the size (reading size) of the original document MS with the device operation unit 602. For example, the user can select and designate the sizes of business cards (55 mm×91 mm) and checks (85 mm×185 mm) from among options for all sizes.

The leading end of the original document MS conveyed in the document turning part D passes through a position where the leading end of the original document MS faces a scan entrance sensor 67. As a result, when the leading end of the original document MS is detected by the scan entrance sensor 67, the conveyance speed of the original document MS by the intermediate roller pair 66 is reduced until the leading end of the original document MS is conveyed to the position of the scan entrance roller pair (including rollers 89 and 90) downstream from the scan entrance sensor 67 in the conveyance direction of the original document MS. As a document reading motor 77 (see FIG. 6) starts to drive and rotate, one roller of the scan entrance roller pair, one roller of a first scan exit roller pair 92, and one roller of a second scan exit roller pair 93 respectively start the rotations.

In the document turning part D, while the original document MS is conveyed in the curved conveyance passage between the intermediate roller pair 66 and the scan entrance roller pair, the upper and lower faces of the original document MS are reversed, and the conveyance direction of the original document MS is turned back. Then, the leading end of the original document MS that has passed through the nip region between the rollers of the scan entrance roller pair passes directly under the registration sensor 65. The operation up to this point after the sheet feeding and separating operation is referred to as a “document pullout operation”.

When the registration sensor 65 detects the leading end of the original document MS, the conveyance speed of the original document MS is gradually decreased through the given conveyance distance. Then, the rotations of the pullout drive roller 86 and the intermediate roller pair 66 are stopped due to the stop of the sheet conveyance motor 192 (see FIG. 6), and the rotation of the scan entrance roller pair is stopped due to the stop of the document reading motor 77. Due to this action, the conveyance of the original document MS is temporarily stopped at the registration position before the first reading and conveying part E. Further, a registration stop signal is sent to the reader controller 603.

### System Configuration

FIG. 6 is a diagram illustrating a configuration of a document processing system according to an embodiment of the present disclosure.

A document processing system 600 includes, for example, the image forming device 1, the ADF 51 attached to the image forming device 1, and an external device 608 capable of communicating with the image forming device 1 or the ADF 51 via the communication network N.

In the example of FIG. 6, the image forming device 1 and the ADF 51 are included in the copier 100. The image forming device 1 is an example of an image forming apparatus. The ADF 51 is an example of a document processing apparatus that is mounted on the image forming apparatus and has an autonomous sheet feed and conveyance mode in which the document processing apparatus autonomously performs a sheet feeding and conveying operation without an instruction from the image forming apparatus.

### Configuration of Image Forming Device

FIG. 6 illustrates a block diagram illustrating a block diagram of a part of an electric circuit of the image forming device 1 (image forming apparatus).

In the example of FIG. 6, the image forming device 1 includes, for example, the device controller 601, a device operation unit 602, a reader controller 603, a display unit 605, and an external communication interface (I/F) 606.

Each of the device controller 601 and the reader controller 603 has a configuration of a computer including, for example, a central processing unit (CPU), a random access memory (RAM), and a read only memory (ROM).

The device operation unit 602 is an input device, such as a touch screen or an operation button, that receives an operation of a user.

The display unit 605 is a display device that displays a display screen such as an operation screen or a setting screen.

The external communication I/F 606 is a communication device that communicates with an external device controller 609 of the external device 608.

### Configuration of ADF

FIG. 6 illustrates a block diagram illustrating a part of an electric circuit of the ADF 51 (document processing apparatus).

In the example of FIG. 6, the ADF 51 includes, for example, the ADF controller 604, the second fixed reading unit 95, sensors 611, a document reading motor 77, a sheet feed motor 76, a sheet conveyance motor 192, a pullout clutch 193, a sheet ejection clutch 194, and an external communication interface (I/F) 607.

The sensors 611 include the document contact sensor 72, a document width sensor 73, the scan entrance sensor 67, the registration sensor 65, a document set sensor 63, the document ejection sensor 61, the first length sensor 57, the second length sensor 58, the third length sensor 202, and the fourth length sensor 201.

The ADF controller 604 has a configuration of a computer including, for example, a CPU, a RAM, and a ROM. Preferably, the ADF controller 604 further includes a storage device. The external communication I/F 607 is a communication device to communicate with the external device controller 609 of the external device 608.

The device controller 601 and the reader controller 603 are connected to communicate with each other. The reader controller 603 and the ADF controller 604 are connected to communicate with each other. The ADF controller 604 and the device controller 601 are connected to communicate with each other. The external device controller 609 and the device controller 601 are connected to communicate with each other. The external device controller 609 and the ADF controller 604 are connected to communicate with each other.

The sheet conveyance motor 192 connected to the ADF controller 604 is a rotation drive source for the pullout drive roller 86 and the document ejection roller pair 94 in the ADF 51.

Further, the pullout clutch 193 connected to the ADF controller 604 connects and disconnects the rotation driving force of the sheet conveyance motor 192 to and from the pullout drive roller 86.

Further, the sheet ejection clutch 194 connects and disconnects the rotation drive force of the sheet conveyance motor 192 to and from the document ejection roller pair 94 as a feeding and conveying device.

After receiving the registration stop signal from the ADF controller 604, the reader controller 603 sends the reading start signal as a sheet feed permission signal to the ADF controller 604. After receiving the reading start signal as a sheet feed permission signal, the ADF controller 604 restarts the rotations of the sheet conveyance motor 192 and the document reading motor 77. Then, the timing at which the leading end of the original document MS reaches the reading position of the first fixed reading unit 151 is calculated based on the pulse counts of the document reading motor 77. At this timing, the ADF controller 604 sends a gate signal indicating an effective image area of the first face of the original document MS in the sub-scanning direction, to the reader controller 603. The ADF controller 604 continues sending the gate signal to the reader controller 603 until the trailing end of the original document MS passes through the reading position of the first fixed reading unit 151, so that the second face of the original document MS is scanned by the first fixed reading unit 151.

The original document MS that has passed through the first reading and conveying part E passes through the first scan exit roller pair 92. Then, the leading end of the original document MS is detected by the document ejection sensor 61. When the single-sided reading mode is set, the second face of the original document MS is not to be read by the second fixed reading unit 95. Then, when the leading end of the original document MS is detected by the document ejection sensor 61, the sheet ejection clutch 194 connects the driving force of the sheet conveyance motor 192 to the document ejection roller pair 94. The timing at which the trailing end of the original document MS passes through the nip region of the document ejection roller pair 94 is calculated based on the pulse count of the sheet conveyance motor after the detection of the leading end of the original document MS by the document ejection sensor 61. Then, based on this calculation result, the sheet ejection clutch 194 is stopped.

On the other hand, when the double-sided reading mode is set, the document ejection sensor 61 initially detects the leading end of the original document MS. Then, the timing of the period to which the original document MS reaches the second fixed reading unit 95 is calculated based on the pulse counts of the document reading motor 77. Then, at the timing at which the calculation result is obtained, the ADF controller 604 sends a gate signal indicating the effective image area of the second face of the original document MS in the sub-scanning direction, to the reader controller 603. The ADF controller 604 continues sending the gate signal to the reader controller 603 until the trailing end of the original document MS passes through the reading position of the second fixed reading unit 95, so that the second face of the original document MS is scanned by the second fixed reading unit 95.

The second fixed reading unit 95 includes contact-type image sensors (CIS) and is coated on the reading face for the purpose of preventing reading vertical streaks due to the paste-like foreign substance adhering to the original document MS to adhere to the reading face of the second fixed reading unit 95.

A second reading roller 96 as a document supporter that supports the original document MS from a non-reading face is disposed at a position facing the second fixed reading unit 95. The second reading roller 96 functions as a floating retainer that prevents the original document MS from floating up at the reading position by the second fixed reading unit 95 and as a reference white portion for acquiring in the shading data on the second fixed reading unit 95.

### Functional Configuration

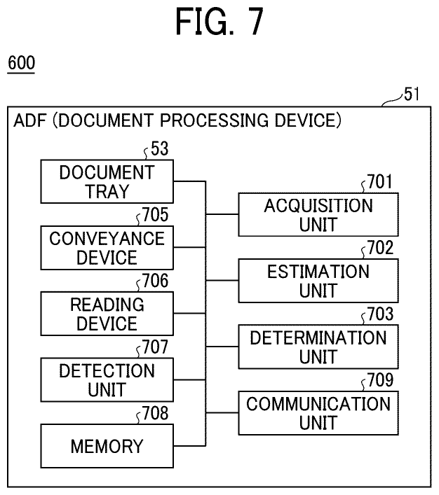

FIG. 7 is a diagram illustrating a functional configuration of a document processing system according to an embodiment of the present disclosure.

The document processing system 600 performs operations achieved by, for example, the ADF 51 (document processing apparatus). In the configuration of FIG. 7, the ADF 51 includes, for example, an acquisition unit 701, an estimation unit 702, a determination unit 703, the document loading tray 53, a conveyance device 705, a reading device 706, a detection unit 707, a memory 708, and a communication unit 709.

The acquisition unit 701 is achieved by, for example, a program executed by the ADF controller 604 to perform the acquisition process to acquire document processing information that is process information of an original document. Preferably, the document processing information includes at least one of a conveyance speed of an original document by the conveyance device, a contact amount, and whether the contact member is stopped or not. Preferably, the document processing information includes at least one of a sheet size, a sheet type, a sheet thickness, and whether there are sheets with mixed sizes.

The estimation unit 702 is achieved by, for example, a program executed by the ADF controller 604 to input document processing information acquired by the acquisition unit 701 and perform the estimation process to estimate the estimation value of the conveyance-failure occurrence rate in response to the result of the reading process of the reading device 706.

The ADF 51 according to the present embodiment includes the autonomous sheet feed and conveyance mode that autonomously performs the sheet feeding and conveying operation without an instruction from the image forming device 1. The estimation unit 702 estimates the estimation value of the conveyance-failure occurrence rate based on the combination data of the document processing information and the conveyance-failure occurrence rate when operated using the autonomous sheet feed and conveyance mode. The conveyance failure includes, for example, any of document leading end fold, document center folding, and wrinkling.

Preferably, the estimation unit 702 uses a pre-trained model that obtains the estimation value of the conveyance-failure occurrence rate in response to execution of the reading process, with the document processing information acquired by the acquisition unit 701 as an input, so that the estimation value of the conveyance-failure occurrence rate is estimated. This pre-trained mode is obtained by machine learning in advance with a training data including combination data of the document processing information and the conveyance-failure occurrence rate when the ADF 51 uses the autonomous sheet feed and conveyance mode.

The determination unit 703 is achieved by, for example, a program executed by the ADF controller 604 to perform the determination process to determine the conveyance control amount when conveying an original document according to the estimation value of the conveyance-failure occurrence rate estimated by the estimation unit 702.

The document loading tray 53 is a tray to which an original document as a reading target is set in the ADF 51. The document loading tray 53 corresponds to, for example, the document setting unit A in FIG. 5.

The conveyance device 705 conveys the original document from the document loading tray 53. The conveyance device 705 corresponds to, for example, a document separating and feeding part B, a registration part C, a document turning part D, a first reading and conveying part E, a second reading and conveying part F, a document ejecting part G, and a document stacking part H.

The reading device 706 performs a reading process to read an image on the original document when the original document is being conveyed by the conveyance device 705. At least a part of the reading device 706 may be disposed outside the ADF 51.

The detection unit 707 is achieved by, for example, a program executed by the sensors 611 and the ADF controller 604 to perform a detection process to detect the position of the original document that is conveyed by the conveyance device 705.

The memory 708 is achieved by, for example, a program executed by the ROM, the RAM, or the storage device and the ADF controller 604, and stores various information or data such as combination data of the document processing information and the conveyance-failure occurrence rate.

The communication unit 709 is achieved by, for example, a program executed by the external communication I/F 607 and the ADF controller 604 to perform the communication process to communicate with the external device controller 609 of the external device 608 such as a cloud server or a personal computer (PC) for design.

The functional configuration of the document processing system illustrated in FIG. 7. For example, at least a part of the functions of the ADF 51 illustrated in FIG. 7 may the controller 7 may be implemented by, for example, the image forming device 1 or the external device 608.

### Process Flow

A description is now given of the flow of a document processing method according to the present embodiment.

### First Embodiment

### Processing of ADF

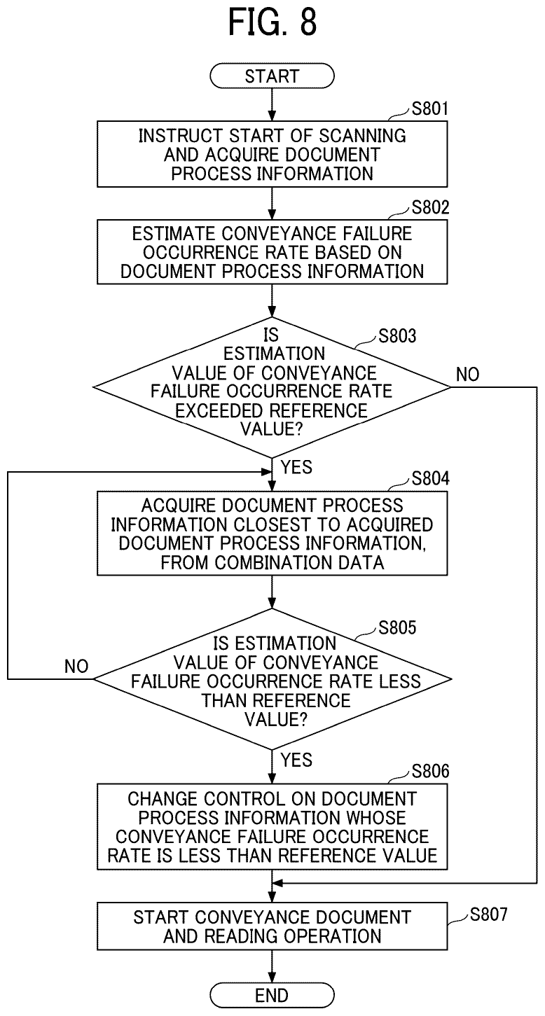

FIG. 8 is a flowchart of a process of the ADF according to a first embodiment of the present disclosure.

The process is an example of the process executed by the ADF 51, for example, when the copier 100 reads an original document.

In step S801, the user presses the copy start key 158 or a scan start button with an original document to be copied or scanned is set on the document loading tray 53, so as to instruct the start of scanning the original document. Thus, the acquisition unit 701 acquires the scan start instruction and the document processing information sent from the image forming device 1.

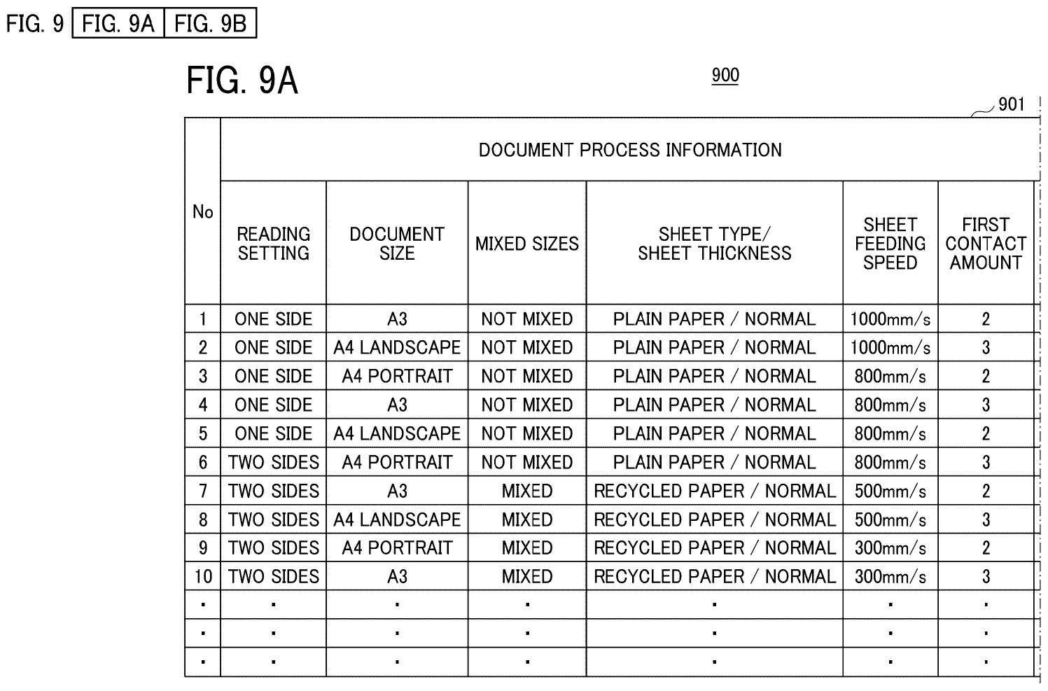

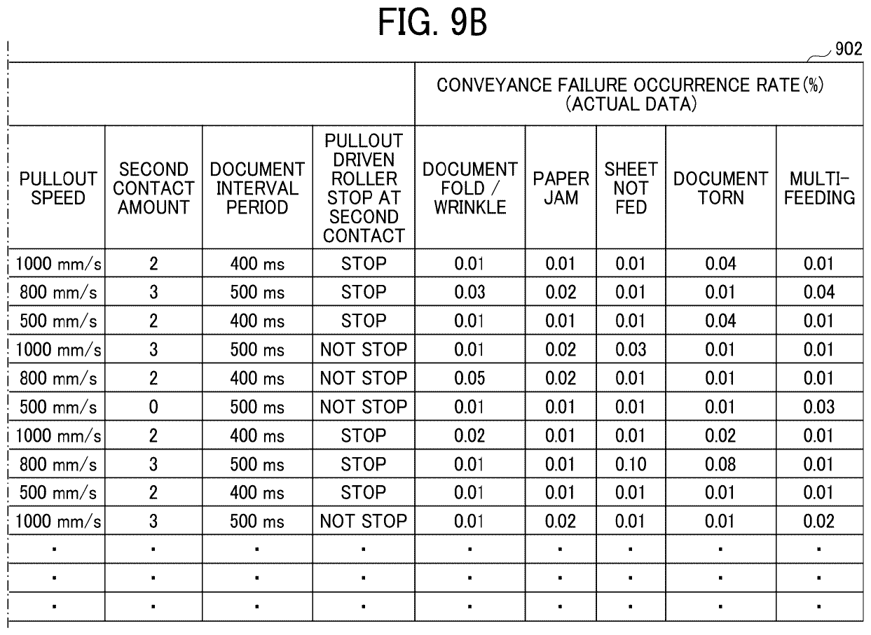

In step S802, the estimation unit 702 estimates the conveyance-failure occurrence rate based on the document processing information acquired by the acquisition unit 701. For example, the estimation unit 702 estimates the conveyance-failure occurrence rate from the document processing information using combination data 900 of the document processing information and the conveyance-failure occurrence rate illustrated in FIG. 9.

FIG. 9 including FIGS. 9A and 9B is a diagram illustrating combination data of document processing information and a conveyance-failure occurrence rate according to an embodiment of the present disclosure.

In the combination data 900 of the document processing information and the conveyance-failure occurrence rate (referred to as combination data 900 below), multiple pieces of document processing information 901 and a conveyance-failure occurrence rate 902 corresponding to each of the multiple pieces of the document processing information 901 are recorded in association with each other.

In the example of FIG. 9, the document processing information 901 includes pieces of information such as a reading setting, a document size, size mixing, sheet type and sheet thickness, a sheet feeding speed, a first contact amount, a pullout speed, a second contact amount, a document interval period, and a determination result of whether a pullout driven roller is stopped at a second contact. Among the pieces of the information, the sheet feeding speed, the first contact amount, the pullout speed, the second contact amount, the document interval period, and the determination result of whether the pullout driven roller is stopped at the second contact are changeable without affection on the reading function. The first contact amount is a contact amount of an original document to the pullout driven roller 87. The second contact amount is a contact amount of an original document to a scan entrance roller pair (including rollers 89 and 90).

The conveyance-failure occurrence rate 902 includes the actual value of an occurrence rate (%) of, for example, a document fold and wrinkle, paper jam, no-sheet feeding, tearing of original document, and multiple feeding.

The ADF 51 stores the combination data 900 of the document processing information and the conveyance-failure occurrence rate in advance in, for example, the memory 708. The estimation unit 702 selects, from the document processing information 901, document processing information that matches the document processing information acquired in step S801 in the order of priority (for estimating the conveyance-failure occurrence rate) described below, or document processing information that has the closest absolute value if there is no document processing information that matches the document processing information acquired in step S801.

### Priority (for Estimating Conveyance-Failure Occurrence Rate)

Determination result of whether the pullout driven roller is stopped or not at the second contact>Sheet feeding speed>Pullout speed>Document interval period>First contact amount>Second contact amount.

The estimation unit 702 sets the conveyance-failure occurrence rate corresponding to the selected document processing information from the combination data 900 as the estimated value of the conveyance-failure occurrence rate.

In step S803, the estimation unit 702 determines whether the estimation value of the conveyance-failure occurrence rate exceeds the reference value. The reference value is a value to determine whether the conveyance-failure occurrence rate is sufficiently low is set in advance. When the estimated value of the conveyance-failure occurrence rate exceeds the reference value (YES in step S803), the estimation unit 702 shifts the process to step S804. On the other hand, when the estimation value of the conveyance-failure occurrence rate exceeds the reference value (NO in step S803), the estimation unit 702 shifts the process to step S807.

When the process shifts to step S804, the estimation unit 702 acquires document processing information closest to the document processing information acquired in step S801 from the combination data 900.

In step S805, the estimation unit 702 determines whether the estimation value of the conveyance-failure occurrence rate corresponding to the document processing information acquired in step S801 is less than the reference value. When the reference value of the conveyance-failure occurrence rate is less than the reference value (YES in step S805), the estimation unit 702 shifts the process to step S806. On the other hand, when the estimation value of the conveyance-failure occurrence rate is not less than the reference value (NO in step S805), the estimation unit 702 shifts the process back to step S804.

As an example of specific processes in steps S804 and S805, the estimation unit 702 changes the changeable document processing information in the order of the subsequent priority (for searching for the closest combination), and if there is document processing information whose conveyance-failure occurrence rate after the change is lower than the reference value, the document processing information at that time is selected.

### Priority (for Searching for Closest Combination)

Document interval period>Sheet feeding speed>Pullout speed>First contact amount>Second contact amount>Determination result of whether the pullout driven roller is stopped or not at the second contact.

For example, the estimation unit 702 searches whether the combination data 900 includes the document processing information in which only the “document interval period” having the highest priority is changed. When the combination data 900 does not include the document processing information or when the combination data 900 includes the document processing information but the conveyance-failure occurrence rate is equal to or greater than the reference value, the estimation unit 702 shifts the process back to step S804.

Returning to step S804, the estimation unit 702 repeatedly searches whether the combination data 900 includes the document processing information in which only “sheet feeding speed” having the second highest priority is changed.

When the process proceeds to step S806, the determination unit 703 changes the control to the document processing information in which the conveyance-failure occurrence rate is less than the reference value in the processes of steps S804 and S805. For example, the determination unit 703 determines the conveyance control amount for conveying the original document by using the document processing information in which the conveyance-failure occurrence rate is less than the reference value.

In step S807, the ADF 51 starts conveying and reading an original document.

By the process in FIG. 8, the ADF 51 can determine the conveyance control amount when conveying the original document so as not to cause a conveyance failure by using the combination data 900 of the document processing information and the conveyance-failure occurrence rate.

### Combination Data Acquisition Process

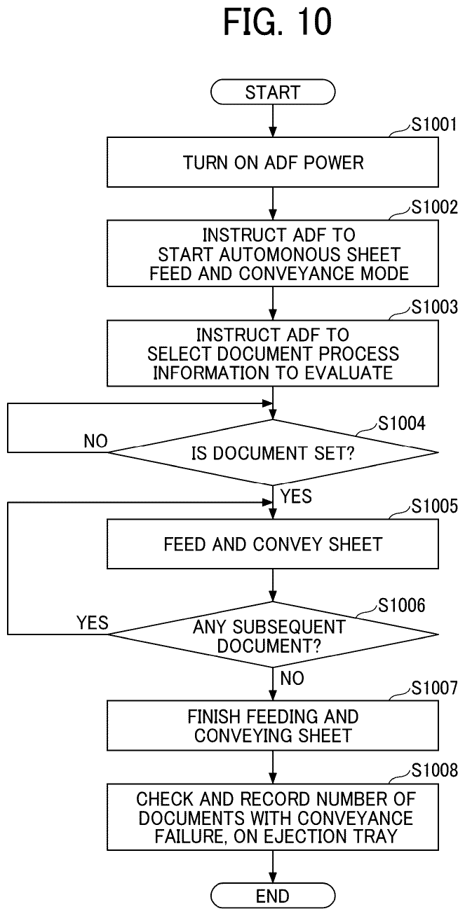

FIG. 10 is a flowchart of an acquisition process of combination data according to an embodiment of the present disclosure.

The ADF 51 according to the present embodiment includes the autonomous sheet feed and conveyance mode that autonomously performs the sheet feeding and conveying operation without an instruction from the image forming apparatus.

FIG. 10 is the flowchart as an example of the process to acquire, the combination data 900 of the document processing information and the conveyance-failure occurrence rate, for example, as illustrated in FIGS. 9A and 9B, by using the autonomous sheet feed and conveyance mode.

The ADF 51 may be attached to the image forming device 1 or may be operated alone without being attached to the image forming device 1. When the ADF 51 is operated alone, the power source is to supply power to the ADF 51. Due to such a configuration, the power is supplied to the ADF 51 by using, for example, a stabilized power supply.

In step S1001, the power supply of the ADF 51 is turned on. As a result, the ADF 51 normally goes into a standby state of communication from the image forming device 1. In order to acquire the combination data 900, the process shifts to step S1002.

In step S1002, the designer uses the communication unit 709 via the external device 608 such as the PC for design, so as to instruct the ADF 51 to start the autonomous sheet feed and conveyance mode. The ADF 51 is programmed to automatically start the sheet conveyance in the autonomous sheet feed and conveyance mode, when the document set sensor 63 detects that the original document is set.

In step S1003, the designer instructs, from the external device 608, the document processing information corresponding to the training data to be acquired. The document processing information includes, for example, the sheet feeding speed, the first contact amount, the pullout speed, the second contact amount, the document interval period, and the determination result of whether the pullout driven roller is stopped at the second contact amount.

In step S1004, the ADF 51 determines whether the original document is set on the document loading tray. When the original document is set on the document loading tray (YES in step S1004), the process proceeds to step S1005. At this time, the designer sets an original document of a size for which the combination data 900 is to be acquired, on the document loading tray.

When the process proceeds to step S1005, the ADF 51 performs the sheet feed and conveyance operation in the autonomous sheet feed and conveyance mode.

In step S1006, the ADF 51 uses the document set sensor 63 to determine whether there is any subsequent original document each time an original document is fed and conveyed.

When there is a subsequent original document (YES in step S1006), the ADF 51 executes the process in step S1005 again. On the other hand, when there is no subsequent original document, the ADF 51 shifts the process to step S1007.

When the process proceeds to step S1007, the ADF 51 finishes the sheet feed and conveyance operation.

In step S1008, for example, the designer checks whether there is any original document that has caused a conveyance failure among the documents stacked on the ejection tray, and records the number of original documents having the conveyance failure if there is any original document with the conveyance failure.

By executing the process of FIG. 10 on various pieces of document processing information, the combination data 900 of the document processing information and the conveyance-failure occurrence rate such as the ones illustrated in FIGS. 9A and 9B, can be created.

### Second Embodiment

In a second embodiment, a description is given of the process in which the estimation unit 702 estimates the conveyance-failure occurrence rate by using the pre-trained mode that returns the estimation value of the conveyance-failure occurrence rate as a result of the reading operation by inputting the document processing information acquired by the acquisition unit 701.

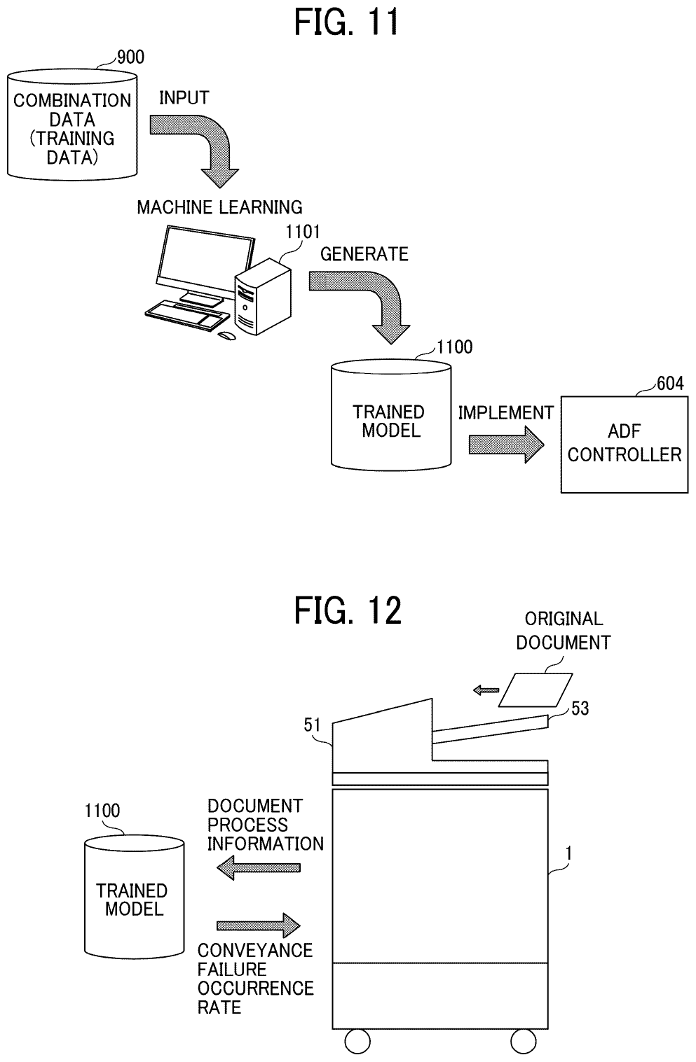

FIG. 11 is a diagram illustrating a result of generation of a pre-trained mode according to a second embodiment of the present disclosure.

In the present embodiment, the pre-trained mode 1100 generated by machine learning is implemented in the control program written in the ADF controller 604 of the ADF 51 that is an example of a document processing apparatus. For example, the pre-trained mode 1100 is generated by machine learning by using a cloud server that can generate the pre-trained mode 1100 or an external device 1101 such as an external personal computer (external PC) with the combination data 900 as a training data. The pre-trained mode 1100 generated by machine learning is a kind of calculation algorithm, and is implemented as a module as a part of a control program.

FIG. 11 illustrates an example in which the pre-trained mode 1100 is implemented in the ADF controller 604 in the ADF 51.

However, the pre-trained mode 1100 may be implemented in the device controller 601 of the image forming device 1, or may be implemented in the external device 1101 such as a cloud server.

In the present embodiment, the pre-trained mode 1100 is generated by machine learning by inputting the document processing information that is the information of an original document to be read as input data, with the conveyance-failure occurrence rate (actual measurement data) that is the information predicted by the inference step.

The document processing information includes pieces of information such as a reading setting (one-sided or duplex), a document size, size mixing, sheet type and sheet thickness, a sheet feeding speed, a first contact amount, a pullout speed, a second contact amount, a document interval period, and a determination result of whether a pullout driven roller is stopped at a second contact. Among these pieces of information, the sheet feeding speed, the first contact amount, the pullout speed, the second contact amount, the document interval period, and whether the pullout driven roller is stopped at the second contact do not affect on the reading function and are changeable. The content of the conveyance-failure occurrence rate includes, for example, the document fold (including wrinkles), paper jam, no-sheet feeding, tearing of original document, and multiple feeding.

FIG. 12 is a diagram illustrating a result of estimation of a conveyance-failure occurrence rate according to the second embodiment of the present disclosure.

In the second embodiment, when actually reading an original document, the conveyance-failure occurrence rate is predicted by the pre-trained mode 1100 generated through machine learning. For example, the estimation unit 702 provides the pre-trained mode 1100 with the document processing information set by the image forming device 1 as input data and receives the conveyance-failure occurrence rate as output data from the pre-trained mode 1100.

The ADF 51 determines whether the conveyance-failure occurrence rate received from the pre-trained mode 1100 exceeds a design reference value. When the conveyance-failure occurrence rate exceeds the design reference value, the setting to the conveyance control amount that is less likely to cause the sheet feed failure such as folding, paper jam, no-sheet feeding, tearing of original document, or multiple feeding is changed.

### Generation Process of Pre-Trained Model

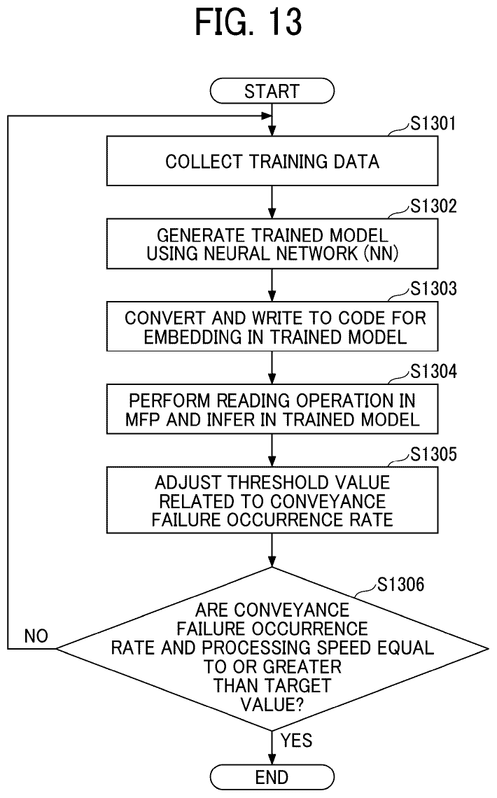

FIG. 13 is a flowchart of a generation process of a pre-trained mode according to the second embodiment of the present disclosure.

This flowchart depicts the flow until the pre-trained model is completed by the deep learning (DL) using the neural network (NN).

In step S1301, the designer collects the training data. For example, the designer uses the ADF 51 and a personal computer for design to execute the acquisition process of the combination data described with reference to FIG. 10. For example, the designer uses the autonomous sheet feed and conveyance mode to feed the original document, and records the number of conveyance failures that have occurred when a large number of original documents (for example, from some hundreds of original documents to some thousands of original documents) is fed for each content of failure such as fold, paper jam, no-sheet feeding, tearing of original document, and multiple feeding. The number of conveyance failures at this time is divided by the number of original documents so that the conveyance-failure occurrence rate can be calculated. The conveyance-failure occurrence rate is information to be estimated and is labeling data. In deep learning, a larger number of information of the training data is better to obtain the pre-trained mode. For this reason, it is preferable to collect a larger number of data in step S1301.

In step S1302, the cloud server or the external device 1101 such as a personal computer for design uses the training data collected in step S1301 to cause the pre-trained mode 1100 to learn by deep learning using the neural network. The pre-trained mode 1100 can be generated with a general Artificial Intelligence (AI) framework. As the AI framework, for example, TensorFlow®, MATLAB®, PyTorch®, ONNX® can be applied.

In step S1303, the designer converts the learned learning model into an incorporation code and writes the incorporation code in, for example, the ADF 51 (or the image forming device 1). The pre-trained mode 1100 generated by the AI framework is often not in a format that can be processed by the CPUs of the ADF 51 or the image forming device 1. Thus, in step S1303, the designer converts the pre-trained mode 1100 into the embedded code (for example, C language) and writes the pre-trained mode 1100 to a board in which the CPUs are embedded.

The conversion into the embedded code can be performed by using a conversion tool provided by a vendor of the CPU. When a unique CPU is used, the conversion into an embedded code by a unique method may be required.

When executing the inference step using the pre-trained mode 1100 by a server on the cloud such as the cloud server 908 instead of the embedded CPUs, the conversion and writing into the embedded code in step S1303 are not to be performed. When executing the inference step using the pre-trained mode 1100 by a server on the cloud such as the cloud server instead of the embedded CPUs, the conversion into a format executable on the cloud server may be performed instead of skipping the conversion and writing into the embedded code. If the conversion into a format executable on the cloud server is required, the conversion is performed.

In step S1304, the designer operates the copier 100 to perform a reading operation to make inference by the pre-trained mode 1100, with the pre-trained mode 1100 after conversion to the ADF 51 (or the image forming device 1) embedded to the pre-trained mode 1100, and estimate and output the conveyance-failure occurrence rate. For example, the designer checks whether the conveyance failure actually occurs in the passing of the original document when the conveyance-failure occurrence rate is equal to or greater than the reference value, and determines whether the conveyance-failure occurrence rate exceeds the target value. The designer records the processing time actually required at that time.

In step S1305, the designer arranges the threshold value related to the conveyance-failure occurrence rate. If the threshold value is set with a higher level, the result comes with a low conveyance-failure occurrence rate. However, as the conveyance parameter is changed, the productivity in reading is generally lowered. On the other hand, if the threshold value is set with a lower level, the result comes with the trade-off relation in which the deterioration in productivity in reading can be restrained but the conveyance-failure occurrence rate increases. For this reason, the threshold value is determined in consideration of the trade-off relation.

In step S1306, the designer determines whether the conveyance-failure occurrence rate and the processing speed are equal to or greater than the target value. When the conveyance-failure occurrence rate and the processing speed are not equal to or greater than the target value (NO in step S1306), the designer shifts the process back to step S1301. On the other hand, when the conveyance-failure occurrence rate and the processing speed are equal to or greater than the target value (YES in step S1306), the designer ends the process of the flowchart of FIG. 13.

For example, in a case where the conveyance-failure occurrence rate has the target value of less than 0.01% and the conveyance failure occurs in more than one original document when feeding 1000 original documents, the designer returns to step S1301 to collect the training data again. In addition to the conveyance-failure occurrence rate, the processing speed also has the target value that, for example, the time to the estimation of the conveyance-failure occurrence rate is equal to or less than the average rate of 500 msec, and is equal to or less than 1000 msec at the maximum. When the target values are not achieved, the process returns to step S1301.

Finally, if the target values can be satisfied for each of the conveyance-failure occurrence rate and the processing speed, the generation of the pre-trained mode 1100 that can be implemented in a product is completed.

In the above description, it is assumed that the designer generates the pre-trained mode and incorporates the pre-trained mode into each ADF 51 to be produced. The tools described above are examples. For example, in the assembly step of the ADF 51 in factory, each ADF 51 after assembly is used from acquisition of the training data to generation of the pre-trained mode. Then, the generated pre-trained mode 1100 can be embedded to the ADF 51. In this case, the pre-trained mode 1100 becomes the pre-trained mode 1100 optimized for the ADF 51. Since it is considered that the accuracy of estimation is enhanced as compared with the pre-trained mode generated by the designer and embedded into each ADF 51, such a process may be performed.

### Processing of ADF

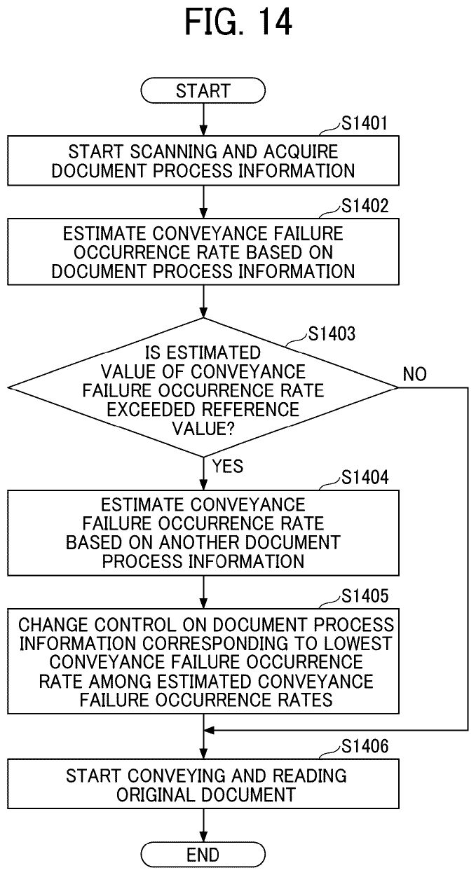

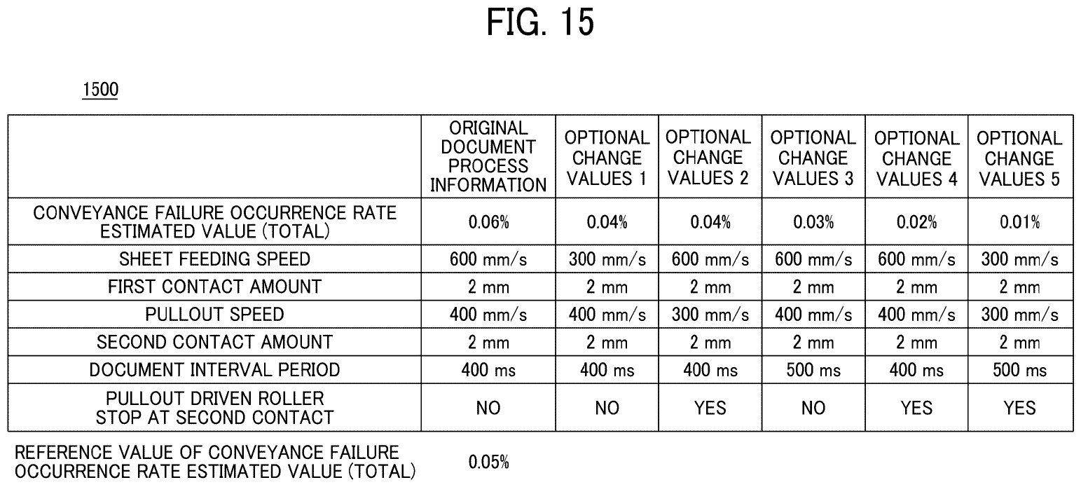

FIG. 14 is a flowchart of a process of the ADF according to the second embodiment of the present disclosure.

This process is an example of the process executed by the ADF 51, for example, when the copier 100 reads an original document. A part of the process is similar to the process of the ADF, illustrated in FIG. 8, according to the first embodiment of the present disclosure. For this reason, the detailed description to the process similar to the process of the ADF according to the first embodiment is omitted.

In step S1401, the user presses the copy start key 158 or a scan start button with an original document to be copied or scanned is set on the document loading tray 53, so as to instruct the start of scanning the original document. Thus, the acquisition unit 701 acquires the scan start instruction and the document processing information sent from the image forming device 1.

In step S1402, the estimation unit 702 estimates the conveyance-failure occurrence rate based on the document processing information acquired by the acquisition unit 701. For example, the estimation unit 702 estimates the conveyance-failure occurrence rate by inputting the document processing information acquired by the acquisition unit 701 into the pre-trained mode 1100.

In step S1403, the estimation unit 702 determines whether the estimation value of the conveyance-failure occurrence rate exceeds the reference value. When the estimated value of the conveyance-failure occurrence rate exceeds the reference value (YES in step S1403), the estimation unit 702 shifts the process to step S1404. On the other hand, when the estimation value of the conveyance-failure occurrence rate does not exceed the reference value (NO in step S1403), the estimation unit 702 shifts the process to step S1406.

In step S1404, the estimation unit 702 estimates the conveyance-failure occurrence rate based on another document processing information. For example, the estimation unit 702 estimates the conveyance-failure occurrence rate from another document processing information by inputting the document processing information after the changeable data of the document processing information is changed, to the pre-trained mode 1100.

In step S1405, the determination unit 703 changes (determines) the conveyance control amount when conveying the original document to the document processing information corresponding to the lowest conveyance-failure occurrence rate of the conveyance-failure occurrence rates estimated in step S1404.

In step S1406, the ADF 51 starts conveying and reading an original document.

When the document processing condition is changed in step S1405, the ADF 51 notifies the image forming device 1 of the change. The image forming device 1 counts the number of notifications from the ADF 51, stores the number of notifications in the ROM of the device controller 601 or a storage device, and sends the counted number of notifications to the external device controller 609 of the external device 608 via the external communication I/F 606 at any timing. The designer can know whether the conveyance-failure occurrence rate has increased when the user has actually used the apparatus under what conditions by acquiring this information from the external device 608, and can use this information as new training data.

### Method of Determining Optimal Document Processing Information

FIG. 15 is a diagram illustrating determination method of optimum document processing information according to the second embodiment of the present disclosure.

The sheet feeding speed in Table 1500 illustrated in FIG. 15 is the maximum speed during conveyance from the start of separation and feeding of the original document to the time when the leading end of the original document reaches the pullout driven roller 87 in the configuration illustrated in the enlarged view of FIG. 5. The pullout speed is the maximum speed during conveyance to the time when the leading end of the original document reaches the scan entrance roller pair (including the rollers 89 and 90) from the pullout driven roller 87. The first contact amount is a contact amount of an original document to the pullout driven roller 87. The second contact amount is a contact amount of an original document to the scan entrance roller pair (including the rollers 89 and 90). The document interval period is a time from when the trailing end of one original document in a continuously conveyed state passes through the first fixed reading unit 151 until the leading end of the subsequent original document reaches the first fixed reading unit 151.

The determination result of whether the pullout driven roller is stopped at the second contact amount is a determination between that the second contact is performed when the pullout driven roller is completely stopped at the second contact (stopped) and that the second contact is performed when the pullout driven roller is rotating at the reading speed (not stopped). The conveyance-failure occurrence rate (total) is the total value of the occurrence rate of all of the conveyance failures (including the fold, paper jam, no-sheet feeding, tearing of original document, and multiple feeding).

The conveyance-failure occurrence rate estimated in step S1402 in the flowchart of FIG. 14 corresponds to 0.06% of the document processing information as original in Table 1500.

Further, the conveyance-failure occurrence rate estimated in step S1404 in the flowchart of FIG. 14 corresponds to the conveyance-failure occurrence rate of each of Optional Change Values 1 to 5 in Table 1500.

For example, when the threshold value of the conveyance-failure occurrence rates (total) related to whether the document processing information (document processing condition) can be changed is 0.05%, the document processing information as original is 0.06% in Table 1500. Thus, the estimation unit 702 changes the document processing information. The estimation unit 702 picks up information that may reduce the conveyance-failure occurrence rate from among the changeable document processing information, raises the candidates from among several patterns, and estimates the conveyance-failure occurrence rate under each condition using the pre-trained mode. As a result, the conveyance-failure occurrence rates (total) illustrated in Table 1500 can be calculated.

In step S1405 of FIG. 14, the determination unit 703 selects the lowest conveyance-failure occurrence rate from the conveyance-failure occurrence rates (total). In the example of Table 1500, since the conveyance-failure occurrence rate of Optional Change Values 5 is the lowest among the conveyance-failure occurrence rates (total), the determination unit 703 selects the document processing information of Optional Change Values 5 and applies the conditions in the subsequent conveyance control.

Alternatively, in Optional Change Values 5, the sheet feeding speed and the pullout speed are decreased, the document interval period is increased, and the determination result is that the pullout driven roller is stopped at the second contact amount. As a result, the number of original documents that can be processed per minute is changed to decrease in each condition. For this reason, the determination unit 703 may select the conveyance-failure occurrence rate of less than 0.5% (all the values correspond to the case) from among Optional Change Values 1 to 4, and may perform a selection for reducing a decrease in the number of original documents that can be processed per minute.

The reason why the conveyance-failure occurrence rate is the lowest for the document processing information of Optional Change Value 5 is that, for example, if the sheet feeding speed and the pullout speed are lowered, the influence of delay of the response speed regarding the start and stop of the driving of the motor in the conveyance control is reduced. As another reason, it is considered that a good influence such as a reduction in deviation in control of the motor drive start and stop timings based on each sensor may be obtained. For these reasons, the probability of occurrence of conveyance failure (such as folding, paper jam, no-sheet feeding, tearing of original document, or multiple feeding) is reduced. Further, it is considered that, by the increase in the document interval period, the overlap of the timings of all the processes on the CPU for processing an original document and the subsequent original document is reduced, the process at the response speed as designed can be performed, and the conveyance-failure occurrence rate is reduced.

### Variations of Functional Configuration

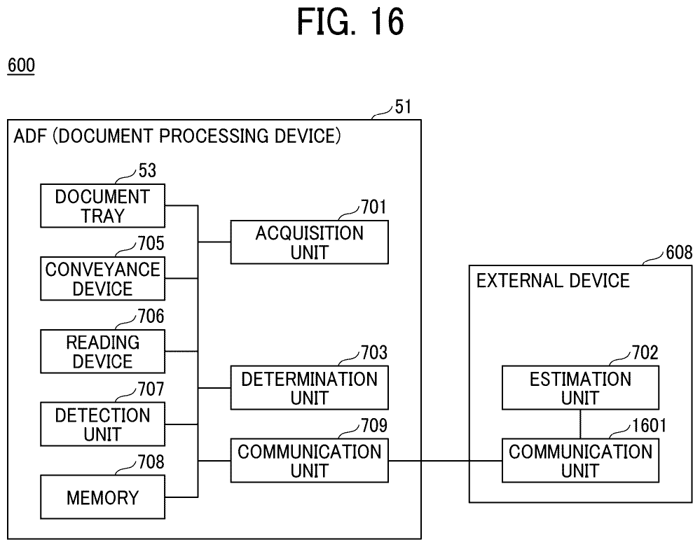

The functional configuration of the document processing system 600 described with reference to FIG. 7 is an example. For example, as illustrated in FIG. 16, the document processing system 600 may include the ADF 51 (document processing apparatus) including the autonomous sheet feed and conveyance mode and the external device 608 such as a cloud server that can communicate with the ADF 51, and the external device 608 may include the estimation unit 702. The estimation unit 702 is achieved by, for example, a program executed by the external device controller 609 (see FIG. 6) to input document processing information acquired by the acquisition unit 701 and perform the estimation process to estimate the estimation value of the conveyance-failure occurrence rate in response to the result of the reading process of the reading device 706. As a result, the CPU performance of the ADF 51 can be reduced, and the ADF 51 can be reduced in cost. For example, the external device 608 such as a cloud server may include the combination data 900 and the pre-trained mode 1100. In this case, the external device 608 may share the combination data 900 and the pre-trained mode 1100 with another system to obtain an efficient leaning and an inference effect.

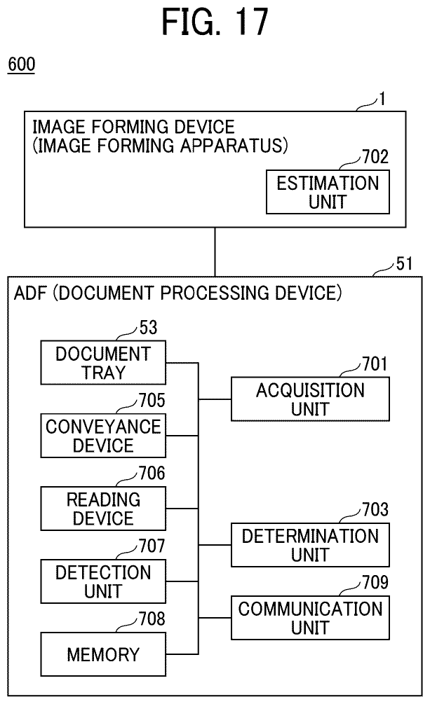

Further, as illustrated in FIG. 17, the document processing system 600 may include the image forming device 1 (image forming apparatus) and the ADF 51 (document processing apparatus) that is attached to the image forming device 1 and has the autonomous sheet feed and conveyance mode, and the image forming device 1 may include the estimation unit 702. The estimation unit 702 is achieved by, for example, a program executed by the device controller 601 to input document processing information acquired by the acquisition unit 701 and perform the estimation process to estimate the estimation value of the conveyance-failure occurrence rate in response to the result of the reading process of the reading device 706. As a result, the CPU performance of the ADF 51 can be reduced, and the ADF 51 can be reduced in cost.

As described above, according to embodiments of the present disclosure, the combination data of document processing information and a conveyance-failure occurrence rate can be easily acquired with a high degree of freedom, and the accuracy of estimation of the conveyance-failure occurrence rate can be enhanced.

### Supplemental Information

Each function of the embodiments described above can be implemented by one processing circuit or a plurality of processing circuits. The term “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit components arranged to perform the recited functions.

### Summary of Embodiment

In this specification, a document processing apparatus and a document processing system according to several examples are disclosed.

### Aspect 1

In Aspect 1, a document processing apparatus has an autonomous sheet feed and conveyance mode that autonomously feeds and conveys a sheet without an instruction from an image forming apparatus, and includes a document tray, a conveyor, an acquisition unit, an estimation unit, and a determination unit. The conveyor conveys an original document from the document tray. The acquisition unit acquires document processing information of the original document. The estimation unit estimates conveyance-failure occurrence rate when a reading operation to read an image on the original document is executed while the original document is being conveyed from the conveyor, with the document processing information acquired by the acquisition unit as an input. The determination unit determines a conveyance control amount during the conveyance of the original document according to an estimation value of the conveyance-failure occurrence rate. The estimation unit estimates the estimation value based on combination data of the document processing information and the conveyance-failure occurrence rate when operated in the autonomous sheet feed and conveyance mode.

According to Aspect 1, by using the autonomous sheet feed and conveyance mode, combination data of document processing information and a conveyance-failure occurrence rate can be generated much easier without using an image forming apparatus in, for example, a laboratory or steps.

Further, the number of manpower is reduced as compared with the case where the autonomous sheet feed and conveyance mode is not used.

### Aspect 2

In Aspect 2, in the document processing apparatus according to Aspect 1, the estimation unit estimates the estimation value using a pre-trained mode that returns an estimation value of the conveyance-failure occurrence rate of a result of the reading operation, with the document processing information acquired by the acquisition unit as an input. The pre-trained mode is a trained model that is obtained by machine learning with training data including combination data of the document processing information and the conveyance-failure occurrence rate when using the autonomous sheet feed and conveyance mode.

According to Aspect 2, by using AI, document processing information including unknown combination can be estimated with higher accuracy.

### Aspect 3

In Aspect 3, in the document processing apparatus according to Aspect 1 or 2, in the state where multiple original documents are continuously conveyed, the document processing information includes information from when the trailing end of a first original document that is conveyed ahead of the other original documents passes a reading position at which the first original document is read by a reading unit to when the leading end of a second original document subsequent to the first original document reaches the reading position.

According to Aspect 3, when a normal reading operation that is not performed in the autonomous sheet feed and conveyance mode is performed, the document interval period of the original document on the document processing apparatus is susceptible to the processing speed of an image forming apparatus. For this reason, the document processing apparatus cannot freely control the document interval period.

By using the autonomous sheet feed and conveyance mode, the document processing apparatus can freely control the document interval period, and the training data that is required for inference of conveyance-failure occurrence rates due to a difference (short or long) in the document interval period can be acquired.

### Aspect 4

In Aspect 4, in the document processing apparatus according to any one of Aspects 1 to 3, the document processing information includes at least one of a conveyance speed of an original document by the conveyor, a contact amount, and a determination result of whether a contact member is stopped at a contact.

### Aspect 5

In Aspect 5, in the document processing apparatus according to any one of Aspects 1 to 4, the document processing information includes at least one of a sheet size, a sheet type, a sheet thickness, and a sheet size mixing.

According to Aspect 5, the accuracy of estimation can be enhanced by inputting document processing information (including sheet thickness, sheet type, sheet size mixing) input by the user.

### Aspect 6

In Aspect 6, in the document processing apparatus according to any one of Aspects 1 to 5, the conveyance failure includes any of a document folding at a leading end, a document folding in the middle, and wrinkling.

### Aspect 7

In Aspect 7, the document processing apparatus according to any one of Aspects 1 to 6 further includes a detector to detect a position of the original document. The conveyance failure includes any of no-sheet feeding, paper jam, and multiple feeding.

### Aspect 8

In Aspect 8, the document processing apparatus according to any one of Aspects 1 to 7 further includes a storage unit and a communication unit to transmit data stored by the storage unit to an external device. The storage unit stores information that the conveyance control amount when conveying the original document, determined by the determination unit, is different from the conveyance control amount before the determination, according to an estimation value of the conveyance-failure occurrence rate. The communication unit transmits the information to the external device.

According to Aspect 8, the training data can be collected by leaving the data as condition data and transmitting the data to an external device while changing control or without changing control.

### Aspect 9

In Aspect 9, in the document processing apparatus according to any one of Aspects 1 to 8, the combination data is data acquired by the document processing apparatus itself, or the pre-trained mode is a trained model generated using the combination data acquired by the document processing apparatus itself as training data.

According to Aspect 9, combination data or a pre-trained mode unique to a machine is generated in, for example, an assembly process of an apparatus. By using the pre-trained mode in consideration of characteristics unique to the machine, an estimation with higher accuracy can be performed.

### Aspect 10

In Aspect 10, a document processing system includes a document processing apparatus having an autonomous sheet feed and conveyance mode that autonomously feeds and conveys a sheet without an instruction from an image forming apparatus, and an external device that can communicate with the document processing apparatus. The document processing apparatus includes a document tray, a conveyor, an acquisition unit, and a determination unit. The conveyor conveys an original document from the document tray. The acquisition unit acquires document processing information of the original document. The determination unit determines a conveyance control amount during the conveyance of the original document according to an estimation value of the conveyance-failure occurrence rate, as a result of execution of a reading operation that reads an image of the original document when the original document is conveyed by the conveyor, estimated based on the document processing information acquired by the acquisition unit. The external device includes an estimation unit that estimates an estimation value of the conveyance-failure occurrence rate, with the document processing information acquired by the acquisition unit as an input. The estimation unit estimates the estimation value based on combination data of the document processing information and the conveyance-failure occurrence rate when operated in the autonomous sheet feed and conveyance mode.

According to Aspect 10, an image forming apparatus may include the CPU that performs estimation. By so doing, a reduction in cost can be achieved.

### Aspect 11

In Aspect 11, a document processing system includes a document processing apparatus having an autonomous sheet feed and conveyance mode that autonomously feeds and conveys a sheet without an instruction from an image forming apparatus, and an external device that can communicate with the document processing apparatus. The document processing apparatus includes a document tray, a conveyor, an acquisition unit, and a determination unit. The conveyor conveys an original document from the document tray. The acquisition unit acquires document processing information of the original document. The determination unit determines a conveyance control amount during the conveyance of the original document according to an estimation value of the conveyance-failure occurrence rate, as a result of execution of a reading operation that reads an image of the original document when the original document is conveyed by the conveyor, estimated based on the document processing information acquired by the acquisition unit. The external device includes an estimation unit that estimates an estimation value of the conveyance-failure occurrence rate, with the document processing information acquired by the acquisition unit as an input. The estimation unit estimates the estimation value based on combination data of the document processing information and the conveyance-failure occurrence rate when operated in the autonomous sheet feed and conveyance mode.

According to Aspect 11, a personal computer on the network may include the CPU that performs estimation. By so doing, a reduction in cost can be achieved.

### Aspect 12

In Aspect 12, a document processing apparatus including a document tray, a conveyor, a reading device, and circuitry. The conveyor conveys an original document from the document tray. The reading device reads an image on the original document conveyed by the conveyor as a reading operation. The circuitry is to acquire document processing information of the original document, estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus, and determine a conveyance control amount of the conveyor to convey the original document according to the conveyance-failure occurrence rate estimated.

### Aspect 13

In Aspect 13, in the document processing apparatus according to Aspect 12, the circuitry is further to estimate the conveyance-failure occurrence rate using a pre-trained model that returns the conveyance-failure occurrence rate, obtained by performing the reading operation, based on the document processing information, and obtain the pre-trained model by machine learning with training data including the combination data.

### Aspect 14

In Aspect 14, in the document processing apparatus according to Aspect 13, the circuitry is further to use the combination data including data acquired by the document processing apparatus.

### Aspect 15

In Aspect 15, in the document processing apparatus according to any one of Aspect 12 to 14, the circuitry is further to use the combination data acquired by the document processing apparatus as training data to generate the pre-trained model.

### Aspect 16

In Aspect 16, in the document processing apparatus according to Aspect 12 or 13, the conveyor continuously conveys multiple original documents including the original document. The multiple original documents includes a first document conveyed to a reading position of the reading device and a second document subsequently conveyed to the reading position after the first document. The circuitry is further to the circuitry is further configured to acquire the document processing information including a period from when a trailing end of the first document passes the reading position to when a leading end of the second document reaches the reading position.

### Aspect 17

In Aspect 17, in the document processing apparatus according to any one of Aspects 11 to 13, the conveyor includes a contact member to contact the original document. The circuitry is to acquire the document processing information including at least one of a conveyance speed of the original document conveyed by the conveyor, a contact amount of the contact member, and a determination result of whether the contact member is stopped.

### Aspect 18

In Aspect 18, in the document processing apparatus according to any one of Aspects 12 to 17, the document processing information includes at least one of a sheet size, a sheet type, a sheet thickness, and a sheet size mixing.

### Aspect 19

In Aspect 19, in the document processing apparatus according to any one of Aspects 12 to 18, a conveyance failure includes any of a document folding at a leading end, a document folding in a middle, and wrinkling.

### Aspect 20

In Aspect 20, in the document processing apparatus according to any one of Aspects 12 to 19, the circuitry is further to detect a position of the original document. A conveyance failure includes any of no-sheet feeding, paper jam, and multiple feeding.

### Aspect 21

In Aspect 21, the document processing apparatus according to any one of Aspects 12 to 20 further includes a memory. The circuitry is further to store, in the memory, information that the conveyance control amount during the conveyance of the original document determined in advance is changed after determination of the conveyance control amount, according to an estimation value of the conveyance-failure occurrence rate, and transmit the information stored in the memory to an external device.

### Aspect 22

In Aspect 22, a document processing system includes an image forming apparatus to form an image on a sheet, and a document processing apparatus attached to the image forming apparatus and having an autonomous sheet feed and conveyance mode that autonomously feeds and conveys an original document without an instruction from the image forming apparatus. The document processing apparatus includes a document tray, a conveyor, a reading device, and circuitry. The conveyor conveys an original document from the document tray. The reading device reads an image on the original document conveyed by the conveyor as a reading operation. The circuitry is to acquire document processing information of the original document, and determine a conveyance control amount of the conveyor to convey the original document according to the conveyance-failure occurrence rate estimated based on the document processing information, as a result of the reading operation. The image forming apparatus includes circuitry to estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus.

### Aspect 23

In Aspect 23, a document processing system includes a document processing apparatus having an autonomous sheet feed and conveyance mode that autonomously feeds and conveys an original document without an instruction from an image forming apparatus, and an external device that communicate with the document processing apparatus. The document processing apparatus includes a document tray, a conveyor, a reading device, and circuitry. The conveyor conveys an original document from the document tray. The reading device reads to read an image on the original document conveyed by the conveyor as a reading operation. The circuitry is to acquire document processing information of the original document, and determine a conveyance control amount of the conveyor to convey the original document according to the conveyance-failure occurrence rate estimated based on the document processing information, as a result of the reading operation. The external device includes circuitry to estimate a conveyance-failure occurrence rate when the reading device reads the image on the original document while the conveyor conveys the original document, based on combination data of the document processing information and the conveyance-failure occurrence rate when the conveyor autonomously conveys the original document in an autonomous conveyance mode without an instruction from an image forming apparatus.

Further, combination data and a pre-trained mode may be on an external cloud server. By so doing, by sharing the combination data and the pre-trained mode with another system, an efficient machine learning and an inference effect can be obtained.

Aspects of the present disclosure are described based on the above-described embodiments, but the present disclosure are not limited to the elements of the above-described embodiments.

The elements of the above-described embodiments can be modified without departing from the gist of the present disclosure, and can be appropriately determined according to the application form.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A document processing apparatus comprising:
a document tray;
a conveyor to convey an original document from the document tray;
a reading device to read an image on the original document conveyed by the conveyor as a reading operation; and
circuitry configured to:
acquire document processing information of the original document;
estimate a conveyance-failure occurrence rate when the reading device reads the image on the original document while the conveyor conveys the original document, based on combination data of:
the document processing information; and
the conveyance-failure occurrence rate when the conveyor autonomously conveys the original document in an autonomous conveyance mode without an instruction from an image forming apparatus; and
determine a conveyance control amount of the conveyor to convey the original document according to the conveyance-failure occurrence rate estimated.

2. The document processing apparatus according to claim 1,
wherein the circuitry is further configured to:
estimate the conveyance-failure occurrence rate using a pre-trained model that returns the conveyance-failure occurrence rate, obtained by performing the reading operation, based on the document processing information; and
obtain the pre-trained model by machine learning with training data including the combination data.

3. The document processing apparatus according to claim 2,
wherein the circuitry is further configured to use the combination data including data acquired by the document processing apparatus.

4. The document processing apparatus according to claim 2,
wherein the circuitry is further configured to use the combination data acquired by the document processing apparatus as training data to generate the pre-trained model.

5. The document processing apparatus according to claim 1,
wherein the conveyor continuously conveys multiple original documents including the original document, the multiple original documents including:
a first document conveyed to a reading position of the reading device; and
a second document subsequently conveyed to the reading position after the first document; and
the circuitry is further configured to acquire the document processing information including:
a period:
from when a trailing end of the first document passes the reading position;
to when a leading end of the second document reaches the reading position.

6. The document processing apparatus according to claim 1,
wherein the conveyor includes a contact member to contact the original document, and
the circuitry acquires the document processing information including at least one of:
a conveyance speed of the original document conveyed by the conveyor;
a contact amount of the contact member; and
a determination result of whether the contact member is stopped.

7. The document processing apparatus according to claim 1,
wherein the document processing information includes at least one of a sheet size, a sheet type, a sheet thickness, and a sheet size mixing.

8. The document processing apparatus according to claim 1,
wherein a conveyance failure includes any of a document folding at a leading end, a document folding in a middle, and wrinkling.

9. The document processing apparatus according to claim 1,
wherein the circuitry is further configured to detect a position of the original document, and
a conveyance failure includes any of no-sheet feeding, paper jam, and multiple feeding.

10. The document processing apparatus according to claim 1, further comprising a memory,
wherein the circuitry is further configured to:
store, in the memory, information that the conveyance control amount during the conveyance of the original document determined in advance is changed after determination of the conveyance control amount, according to an estimation value of the conveyance-failure occurrence rate; and
transmit the information stored in the memory to an external device.

11. A document processing system comprising:
an image forming apparatus to form an image on a sheet; and
a document processing apparatus attached to the image forming apparatus and having an autonomous sheet feed and conveyance mode that autonomously feeds and conveys an original document without an instruction from the image forming apparatus,
wherein the document processing apparatus comprises:
a document tray;
a conveyor to convey an original document from the document tray;
a reading device to read an image on the original document conveyed by the conveyor as a reading operation; and
circuitry configured to:
acquire document processing information of the original document; and
determine a conveyance control amount of the conveyor to convey the original document according to the conveyance-failure occurrence rate estimated based on the document processing information, as a result of the reading operation, and
the image forming apparatus comprises circuitry configured to estimate a conveyance-failure occurrence rate when the reading device reads the image on the original document while the conveyor conveys the original document, based on combination data of:
the document processing information; and
the conveyance-failure occurrence rate when the conveyor autonomously conveys the original document in an autonomous conveyance mode without an instruction from an image forming apparatus.

12. A document processing system comprising:
a document processing apparatus having an autonomous sheet feed and conveyance mode that autonomously feeds and conveys an original document without an instruction from an image forming apparatus; and
an external device that communicate with the document processing apparatus,
wherein the document processing apparatus comprises:
a document tray;
a conveyor to convey an original document from the document tray;
a reading device to read an image on the original document conveyed by the conveyor as a reading operation; and
circuitry configured to:
acquire document processing information of the original document; and
determine a conveyance control amount of the conveyor to convey the original document according to the conveyance-failure occurrence rate estimated based on the document processing information, as a result of the reading operation, and
the external device comprises circuitry configured to estimate a conveyance-failure occurrence rate when the reading device reads the image on the original document while the conveyor conveys the original document, based on combination data of:
the document processing information; and
the conveyance-failure occurrence rate when the conveyor autonomously conveys the original document in an autonomous conveyance mode without an instruction from an image forming apparatus.
